(19) United States
(12) Patent Application Publication
(10) Pub. No.: US 2025/0301471 A1
(43) Pub. Date: Sep. 25, 2025

(54) METHOD PERFORMED BY USER EQUIPMENT, METHOD PERFORMED BY BASE STATION, AND CORRESPONDING DEVICES THEREOF

(71) Applicant: Samsung Electronics Co., Ltd., Gyeonggi-do (KR)

(72) Inventors: Jingxing FU, Beijing (CN); Feifei SUN, Beijing (CN); Sa ZHANG, Beijing (CN)

(21) Appl. No.: 18/860,145

(22) PCT Filed: Apr. 27, 2023
(86) PCT No.: PCT/KR2023/005792

§ 371 Date: Oct. 25, 2024

(30) Foreign Application Priority Data
Apr. 27, 2022 (CN) 202210459573.5

(51) Int. Cl. H04W 72/21; H04L 5/00

(52) U.S. Cl. CPC H04W 72/21; H04L 5/0044

(57) ABSTRACT

The disclosure relates to a 5G or 6G communication system for supporting a higher data transmission rate. The present disclosure provides a method performed by a user equipment in a wireless communication system, a method performed by a base station, and corresponding devices thereof, and belong to the technical field of communication. The method performed by a user equipment comprises: receiving, from a base station (BS), first information associated with an uplink (UL) transmission (Tx) switching for a dual UL Tx chains including a first UL Tx chain and a second UL Tx chain, wherein the first information indicates whether to: switch both of the first UL Tx chain and the second UL Tx chain to a first UL carrier, or switch one of the first UL Tx chain or the second UL Tx chain to the first UL carrier; and transmitting, to the BS, a UL signal on the first UL carrier based on the first UL Tx chain or based on both of the first UL Tx chain and the second UL Tx chain, according to the first information. Based on the methods provided by embodiments of the present disclosure, the base station can schedule the user equipment more flexibly, thereby improving the effective utilization of system resources and improving communication performance.

### TECHNICAL FIELD

The present disclosure relates to the technical field of communication, and more par-ticularly to a method performed by a user equipment in a wireless communication system, a method performed by a base station, a user equipment, a base station, and a computer-readable storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

How to better improve the exiting wireless communication modes and better satisfy the communication requirements is a technical problem that is being studied by those skilled in the art.

### DISCLOSURE OF INVENTION

### Solution to Problem

The purpose of the present disclosure is to solve at least one of the technical defects in the existing communications modes so as to better satisfy the communication requirements. For this purpose, the present disclosure provides the following technical solutions.

In one aspect, an embodiment of the present disclosure provides a method performed by a user equipment in a wireless communication system, including:
receiving first information transmitted by a base station, the first information includes related information of a scheduled uplink resource and a transmission mode;
and
determining an uplink transmission chain state of the user equipment according to the first information.

In another aspect, an embodiment of the present disclosure provides a method performed by a base station in a wireless communication system, including:
transmitting first information to a user equipment, wherein the first information is configured to determine an uplink transmission chain state of the user equipment, wherein the first information includes related information of a scheduled uplink resource and a transmission mode.

In still another aspect, an embodiment of the present disclosure further provides a user equipment, including: a transceiver and a processor, the processor being coupled to the transceiver and configured to execute the method performed by a user equipment according to any one of the optional embodiments of the present disclosure.

In yet another aspect, an embodiment of the present disclosure further provides a base station, including: a transceiver and a processor, the processor being coupled to the transceiver and configured to implement the method performed by a base station according to any one of the optional embodiments of the present disclosure.

In yet another aspect, an embodiment of the present disclosure further provides a computer-readable storage medium having computer programs stored thereon that, when executed by a processor, implement the method according to any one of the optional embodiments of the present disclosure.

In yet another aspect, an embodiment of the present disclosure further provides a computer program product, including computer programs that, when executed by a processor, implement the method according to any one of the optional embodiments of the present disclosure.

The beneficial effects brought by the technical solutions provided in embodiments of the present disclosure will be described hereinafter with reference to specific optional embodiments, or can be understood from the description of the embodiments, or can be appreciated by practicing the embodiments.

### BRIEF DESCRIPTION OF DRAWINGS

To describe the technical solutions of the embodiments of the present disclosure more clearly, the accompanying drawings to be used in the description of the embodiments of the present disclosure will be described below briefly.

FIG. 1 illustrates an example wireless network according to an embodiment of the present disclosure;

FIG. 2A illustrates an example wireless transmitting path according to an embodiment of the present disclosure;

FIG. 2B illustrates an example wireless reception path according to an embodiment of the present disclosure;

FIG. 3A illustrates an example user equipment according to an embodiment of the present disclosure;

FIG. 3B illustrates an example base station according to an embodiment of the present disclosure;

FIG. 4 illustrates a flowchart of a communication method according to an embodiment of the present disclosure;

FIGS. 5 and 6 illustrate two schematic diagrams of performing uplink transmission by a user equipment that supports two uplink transmission chains according to an embodiment of the present disclosure, respectively;

FIGS. 7 and 8 illustrate two schematic diagrams when a user equipment can switch uplink transmission chain states, respectively;

FIGS. 9, 10, and 11 illustrate schematic diagrams of three solutions for determining the uplink transmission chain state of the user equipment, respectively;

FIG. 12 illustrates a schematic structure diagram of an electronic device to which an embodiment of the present disclosure is applied;

FIG. 13 illustrates a block diagram illustrating a structure of a UE according to an embodiment of the disclosure; and

FIG. 14 illustrates a block diagram illustrating a structure of a base station according to an embodiment of the disclosure, according to the embodiments as disclosed herein.

### MODE FOR THE INVENTION

Embodiments of the present disclosure are described below in connection with the accompanying drawings in the present disclosure. It should be understood that the embodiments set forth below in conjunction with the accompanying drawings are exemplary descriptions used to explain the technical solutions of the embodiments of the present disclosure and do not constitute a limitation of the technical solutions of the embodiments of the present disclosure.

It should be understood by one person of ordinary skill in the art that singular forms “a”, “an”, “the”, and “said” may be intended to include plural forms as well, unless otherwise stated. It should be further understood that the terms “includes” and “comprises” as used in this application embodiment mean that the corresponding feature may be implemented as the feature, information, data, step, operation, component and/or assembly presented, but does not exclude the implementation of other features, information, data, steps, operations, components, assemblies, and/or combinations thereof, etc. supported in the art. It should be understood that when we refer to a component being “connected” or “coupled” to another component, the component may be directly connected or coupled to the other component, or it may refer to the component and the other component being connected through an intermediate component. In addition, “connected to” or “coupled to” as used herein can comprise wireless connection or coupling. The term “and/or” as used herein indicates at least one of the items defined by the term, for example, “A and/or B” may be implemented as “A”, or as “B”, or as “A and B”. When describing multiple (two or more) items, if the relationships among the multiple items are not clearly defined, the multiple items may refer to one, many or all of the multiple items. For example, the description of “parameter A includes A1, A2, and A3” can be implemented as parameter A includes A1, A2, or A3, or as parameter A includes at least two of the three pa-rameters A1, A2, and A3.

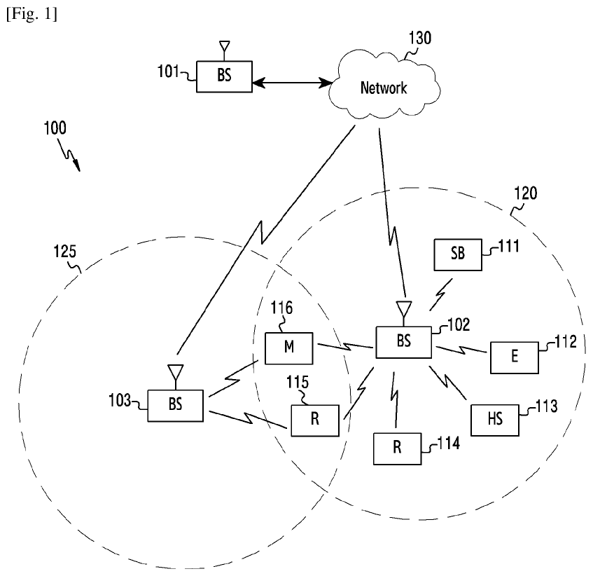

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio en-vironment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

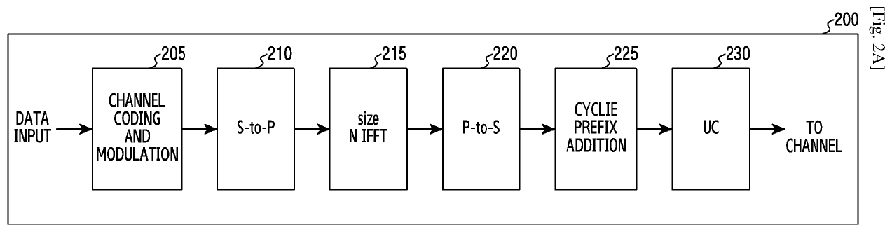

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

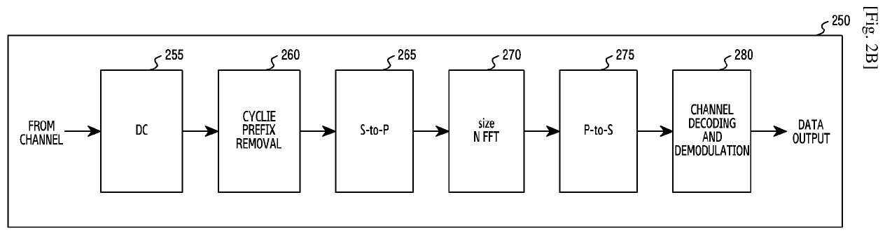

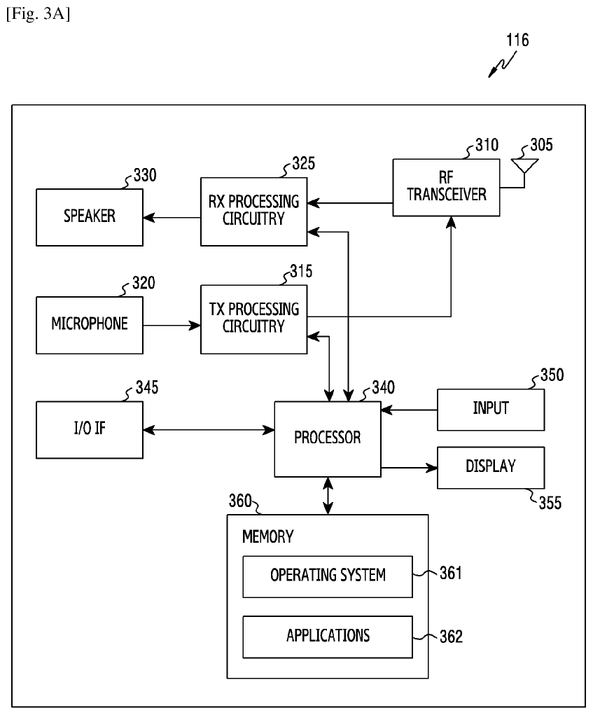

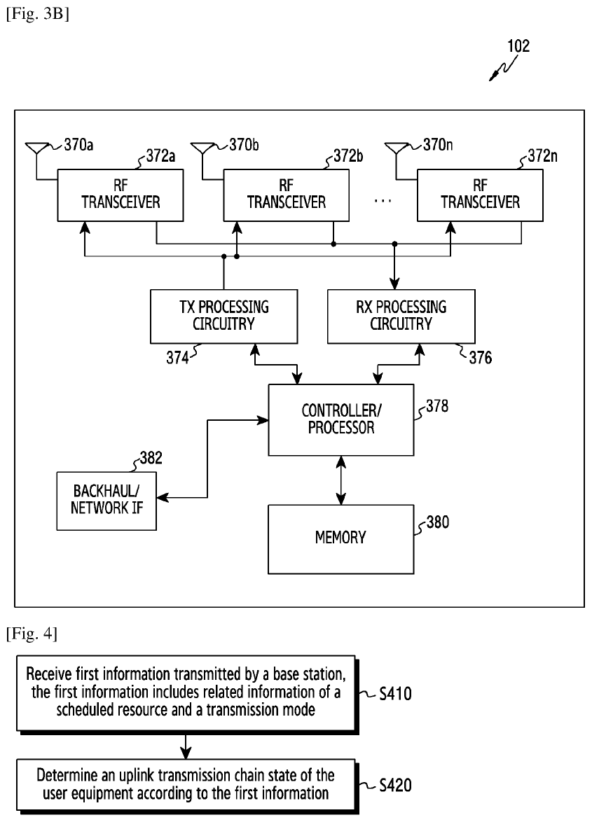

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these ac-cessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It should be understood that the solutions provided in the embodiments of the present disclosure can be applied to, but not limited to, the above wireless network.

In wireless communication systems, the transmission from a base station to a user equipment (UE) is called downlink, and the transmission from a UE to a base station is called uplink. The uplink corresponds to an uplink transmission (also referred to as uplink transmitting, uplink transmit, etc.), and the uplink transmission includes at least one of transmission of uplink channels and transmission of uplink signals, wherein the uplink channels include physical uplink shared channels (PUSCHs), physical uplink control channels (PUCCHs) and physical random access channels (PRACHs), and the uplink signals include, but not limited to, uplink reference signals.

In the existing uplink transmission, the UE may support one or two transmission chains, and the UE may be configured with two uplink carriers. When the UE supports two transmission chains, the uplink transmission may be at two ports (antenna ports) of one uplink carrier, or at one port of one carrier and one port of another uplink carrier. Although the UE can fully utilize uplink resources to a certain extent when it performs uplink transmission on two carriers, the implementation is relatively fixed, and the resource utilization is not flexible, so that improvements are still needed.

Therefore, the embodiments of the present disclosure provide a communication method in order to utilize uplink resources more fully and flexibly and improve communication performance.

The technical solutions of the present disclosure and how to solve the above technical problems by the technical solutions of the present disclosure will be described below in detail by specific embodiments. The following specific embodiments can be combined with each other, and the same or similar concepts or processes may not be repeated in some embodiments. The embodiments of the present disclosure will be described below with reference to the accompanying drawings. The text and the accompanying drawings in the following description are merely provided as examples to help readers to understand the present disclosure. They are not intended to limit the scope of the present disclosure in any way. Although some embodiments and examples have been provided, based on the contents disclosed herein, it is obvious to those skilled in the art that alterations may be made to the illustrated embodiments and examples without departing from the scope of the present disclosure.

FIG. 4 illustrates a flowchart of a method performed by a user equipment in a communication system according to an embodiment of the present disclosure. As shown in FIG. 4, the method may include the following actions.

At step S410, first information transmitted by a base station is received, the first in-formation includes related information of a scheduled resource and a transmission mode.

At step S420, an uplink transmission chain state of the user equipment is determined according to the first information.

In the embodiment of the present disclosure, the uplink resource may be an uplink carrier, an uplink serving cell, or an uplink bandwidth part (BWP). Correspondingly, the first information may include the scheduling information of the uplink carrier, the uplink serving cell, or the uplink BWP corresponding to at least one uplink transmission chain. For convenience of description, in some embodiments or examples below, the uplink resource will be described by taking an uplink carrier as an example.

The first information includes the scheduling information of an uplink resource, i.e., uplink resource scheduling information. The base station transmits the scheduling in-formation to the UE to realize the scheduling of the uplink resource of the UE. The way of scheduling the UE by the base station will not be limited to the embodiment of the present disclosure, and may be periodic scheduling, aperiodic scheduling, dynamic scheduling, dynamic scheduling or semi-persistent scheduling. In practical implementations, the scheduling mode may correspond to the specific communication scenario.

It is to be noted that, the information name of the first information will not be limited in the embodiments of the present disclosure, and the information name may be scheduling information or other information names or message names, such as downlink control information (DCI) or indication information (e.g., semi-static indication information). The first information may specifically indicate how many uplink resources the uplink transmission information (e.g., uplink channels, uplink reference signals) in a time unit is simultaneously transmitted in a one-port or two-port transmission mode. The granularity of the time unit will not be limited in the embodiment of the present disclosure. For example, the time unit may include, but is not limited to, a time slot, or a period of time with another time duration.

Optionally, the first information may schedule at least one uplink resource and the transmission mode corresponding to the uplink resource. That is, the uplink resource corresponding to at least one uplink transmission chain and the corresponding transmission mode can be known according to the first information. The transmission mode is 1-port/one-port transmission or dual-port transmission (i.e., 2-port/two-port transmission).

When the UE is configured to support two uplink transmission chains (dualUL) and when the UE supports two-port transmission on one uplink resource, the UE can know, based on the first information, an uplink resource where at least one uplink transmission chain is located, and the corresponding transmission mode when the uplink resource is used for uplink transmission, i.e., at least one port transmission being performed on which uplink resource. The specific form of realizing the indication will not be limited to the embodiment of the present disclosure, and may be explicit indication information or implicit indication information. Optionally, the first information may include identification information of the uplink resource and a transmission mode indicator. The specific form of the identification information and the transmission mode indicator will also not be limited in the present disclosure. For example, the identification information of the uplink resource may include, but is not limited to, the index of the uplink resource. A transmission mode indicator of 0 indicates one-port transmission, while an indicator of 1 indicates two-port transmission.

As an example, if it is assumed that the UE is configured with three uplink carriers, the indexes of the three uplink carriers are 1, 2, and 3, respectively, and the first in-formation includes a carrier index 1 and a transmission mode indicator 0, the UE may determine based on the first information that one uplink transmission chain is on an uplink carrier with an index of 1 and the transmission mode on this carrier is one-port transmission. It is to be noted that the uplink resource and transmission mode scheduled by the first information are the actual transmission mode of the uplink resource of the UE, that is, the UE performs actual uplink transmission according to the scheduled uplink resource and corresponding transmission mode of the first in-formation.

In embodiments of the present disclosure, the uplink transmission chain state of the UE is the transmission mode of the UE's uplink resource considered by the UE, which is not necessarily the same as the actual transmission mode of the uplink resource of the UE. For example, the actual uplink transmission mode determined by the UE according to the first information may be one-port transmission on the first uplink carrier, and the uplink transmission chain state considered by the UE may be one-port transmission on the first carrier or one-port transmission on the second carrier.

The specific implementation of transmitting the first information to the UE by the base station will not be limited to the embodiments of the present disclosure. Optionally, the UE may acquire the first information by receiving DCI transmitted by the base station. The first information includes scheduling information about one uplink resource or scheduling information about two uplink resources. If the first information includes scheduling information about two uplink resources, the two pieces of scheduling information may be transmitted to the UE by the base station through different DCI, respectively.

In embodiments of the present disclosure, the uplink transmission chain state of the user equipment can be interpreted as the uplink transmission mode or case adopted by the user equipment, i.e., the uplink resource, where the port transmission is located, considered by the UE among L configured uplink resources of the user equipment, i.e., the uplink resource, where two uplink transmission chains are located, considered by the user equipment. It is also possible to include the transmission mode of the uplink resource where the uplink transmission chain is located, i.e., the transmission mode of each uplink resource among a plurality of configured uplink resources of the user equipment, for example, one-port transmission, two-port transmission or no-port transmission. For example, the supported two-port transmission considered by the UE occurs on one uplink resource or two uplink resources (that is, two uplink resources correspond to one-port transmission, respectively).

When it is necessary to perform uplink transmission, the UE may transmit, based on the uplink resource scheduled by the first information and the corresponding transmission mode, uplink information to the base station on the corresponding uplink resource in the corresponding transmission mode. The uplink information includes at least one of an uplink channel and an uplink signal. The uplink signal may include an uplink reference signal, for example, a sounding reference signal (SRS).

Optionally, the method provided in embodiments of the present disclosure may be applied to a user equipment that supports two uplink transmission chains (TX chains), and the user equipment may be configured with L uplink resources, where L≥2. As an optional implementation, the L uplink resources may be at least three uplink resources.

Optionally, the method in embodiments of the present disclosure further includes:
receiving configuration information, the configuration information including a configuration related to uplink resources of the user equipment, i.e., being used to determine uplink resources of the user equipment.

Optionally, the configuration information includes the number of uplink resources and identification information (e.g., at least one of the indexes of the uplink resource, the time-domain or frequency-domain position corresponding to the uplink resource, etc.). Optionally, the configuration information may further include the initial uplink transmission chain state of the user equipment, for example, two uplink transmission chains supported by the user equipment being on which uplink resource(s). As an example, it is assumed that three uplink carriers are configured for the UE through a higher-layer signaling and have indexes of 1, 2, and 3, respectively, and it is indicated that two uplink transmission chains of the UE are on the uplink carrier with an index of 1, or one uplink transmission chain is on the uplink carrier with the index of 1 while another uplink transmission chain is on the uplink carrier with an index of 2. According to the above configuration, the UE can know the initial transmission mode of the uplink resource (the initial transmission chain state considered by the UE).

It should be understood that, if the UE is configured with the initial uplink transmission chain state, when the UE receives the first information for the first time upon receiving the configuration information and when the UE determines the uplink transmission chain state of the user equipment according to the first information, the initial uplink transmission chain state is a preceding uplink transmission chain state of the UE (the preceding uplink transmission chain state may refer to the following description); and, when the UE receives the first information for the second time and sub-sequently, the preceding uplink transmission chain state of the UE is the uplink transmission chain state determined by the UE for the last time. At this time, the preceding uplink transmission chain state of the UE may be the initial uplink transmission chain state (the uplink transmission chain state of the UE has not been switched) or may not be the initial uplink transmission chain state.

Optionally, by taking the uplink resource being an uplink carrier as an example, the method provided by the present disclosure may include the following steps during implementation.

At step S410, a UE receives first information transmitted by a base station, the first information includes related information of a scheduled resources and a transmission mode.

At step S420, the UE determines, based on the received first information, an uplink transmission chain state considered by the UE, i.e., an uplink carrier where two uplink transmission chains or uplink transmission ports considered by the UE occur.

Optionally, the method further includes: transmitting, by the UE and according to the uplink resource and transmission mode scheduled by the first information, at least one of an uplink channel and an uplink reference signal to the base station.

In other words, in embodiments of the present disclosure, the uplink resource and transmission mode scheduled by the first information are an actual transmission mode in which the UE performs uplink transmission, and the uplink transmission chain state of the UE is the transmission mode of the uplink resource considered by the UE. For example, if the UE is configured with three uplink carriers with indexes of 1, 2, and 3 and the first information has scheduled a carrier with an index of 1 for one-port transmission, the actual uplink resource transmission mode of the UE may be denoted as 1P+0P+0P, that is, one-port transmission is performed on a carrier with an index of 1. If it is determined based on the method provided in embodiments of the present disclosure that another uplink transmission chain of the UE is on a carrier with an index of 2, the uplink transmission chain state of the UE may be denoted as 1T+1T+0T, that is, the UE should consider that the one-port transmission of the UE occurs on a carrier with the index of 1 and a carrier with the index of 2. If it is determined based on the method provided in embodiments of the present disclosure that another uplink transmission chain of the UE occurs on a carrier with the index of 1, the uplink transmission chain state of the UE may be denoted as 2T+0T+0T, that is, the UE should consider that the two-port transmission of the UE occurs on the uplink carrier with an index of 1.

Before the step S410, the method further includes: receiving configuration in-formation about uplink resources, wherein the configuration information may include the number and indexes of uplink resources. Optionally, the configuration information may also indicate the initial uplink transmission chain state of the user equipment.

When the UE supports two uplink transmission chains, the UE can use two uplink transmission chains to transmit uplink channels or signals on at most two uplink carriers. In a case where the base station configures more than two uplink carriers for the UE, the UE may have more possible uplink transmission chain states, and the UE may determine the current uplink transmission chain state of the UE according to the scheduling of the base station and may perform uplink transmission based on the scheduling information.

In the method provided in embodiments of the present disclosure, it is also possible to determine the uplink transmission chain state of the UE when the base station configures that the UE can use two uplink transmission chains to transmit uplink channels or signals on at most two uplink carriers. For example, the UE is configured with three uplink carriers by receiving a higher-layer signaling (that is, three uplink resources are configured for the UE through a higher-layer configuration), and the uplink state is that there is one uplink on the first uplink carrier, there is one uplink on the second uplink carrier and there is no uplink on the third uplink carrier, so that the uplink state of the UE is 1T+1T+0T (the initial uplink transmission chain state configured by the higher-layer signaling). When it is necessary to perform uplink resource scheduling, the UE may determine the current uplink transmission chain state of the UE according to the first information transmitted by the base station. Optionally, the transmission mode of at least one uplink resource may be determined according to the first information, and it may be determined, according to the determined transmission mode of at least one uplink resource and the preceding transmission mode of the uplink resource of the UE, whether to switch the uplink transmission chain state. If it is necessary to switch the uplink transmission chain state, the current transmission chain state may be determined according to the first information. It can be known from the above description that, if the uplink resource scheduling is the first scheduling of the UE after receiving a higher-layer signaling configuration, the preceding uplink transmission chain state of the UE is 1T+1T+0T of the higher-layer configuration; and, if the uplink resource scheduling is not the first scheduling, the preceding transmission chain state of the UE is the uplink transmission chain state determined by the UE during the last scheduling.

As another optional implementation, it is also possible to not configure the initial transmission chain state through the higher-layer signaling. During the first scheduling, the UE may consider that the uplink transmission mode is to be switched, and the transmission chain state of the UE may be determined according to the first in-formation. In the method provided in embodiments of the present disclosure, in a case where the UE supports two uplink transmission chains, the base station may configure more than two uplink resources for the UE, and the UE may perform the method provided in embodiments of the present disclosure to determine, according to the first information received from the base station, an uplink resource where two uplink transmission chains are located should be considered by the UE or a link state corresponding to each uplink resource of the UE, for example, whether each uplink resource has an uplink transmission chain or transmission port.

Based on the method provided in embodiments of the present disclosure, the base station can configure a plurality of uplink resources for the UE, so that the resource scheduling of the UE can be realized more flexibly. In a case where the UE supports two uplink transmission chains, the UE can perform uplink transmission on the better uplink resource among the plurality of uplink resources through scheduling, so that the communication effect of uplink transmission can be better ensured.

It should be understood that, during the actual implementation process, the number of uplink resources configured for the UE by the base station may also be 2. For example, there are two uplink carriers. In other words, the value of L in practical applications may also be 2. Due to the limited uplink transmission capability of the UE, the UE may perform simultaneous transmission on at most N (N may be 2) uplink carriers in a one-port transmission mode, the UE may perform simultaneous transmission on at most M (M may be 1) uplink carriers in a two-port transmission mode, and the number of uplink carriers configured for the UE by the base station is L (L is a positive integer; for example, L may be equal to 2, 3, 4, etc.), where L may be greater than N and greater than M. The method provided by the present disclosure can be used in combination with the existing communication modes when the method provided in embodiments of the present disclosure does not contradict or conflict with the existing communication modes.

In an optional embodiment of the present disclosure, the step S420 of determining an uplink transmission chain state of the user equipment according to the first information may include:
determining the uplink transmission chain state of the user equipment when it is determined according to the first information and the preceding uplink transmission chain state (the preceding transmission mode of the uplink resource) that the uplink transmission chain state of the user equipment is switched.

When it is determined that the uplink transmission chain state of the user equipment is not switched, the preceding uplink transmission chain state of the user equipment is used as the uplink transmission chain state of the user equipment.

The preceding uplink transmission chain state of the user equipment refers to the uplink resource and transmission mode corresponding to the preceding uplink transmission of the UE.

Upon receiving the first information transmitted by the base station, the UE may determine, according to the information, an uplink resource and a transmission mode corresponding to one or two uplink transmission chains of the UE. Based on the determined uplink resource and transmission mode and the preceding uplink transmission chain state, the UE may determine whether to switch the uplink transmission chain state. It is determined to not switch the uplink transmission chain state, the current uplink transmission chain state of the UE is the preceding uplink transmission chain state, that is, the preceding uplink transmission chain state is maintained; and, if it is determined to switch the uplink transmission chain state, the current uplink transmission chain state of the UE may be determined according to the first in-formation.

It should be understood that, if the uplink resource and transmission mode corresponding to two uplink transmission chains of the UE can be determined according to the first information, the current uplink transmission chain state of the UE is the uplink resource corresponding to two uplink transmission chains determined according to the first information; and, if an uplink resource corresponding to one uplink transmission chain is determined according to the first information, and when it is determined to switch the uplink transmission chain state, the UE needs to further determine an uplink resource where another uplink transmission chain is located. Specifically, the uplink resource corresponding to one uplink transmission chain may be determined according to the first information (i. e. there is one port transmission on the scheduled uplink resource), and the uplink resource corresponding to another uplink transmission chain may be determined according to the higher-layer configuration or protocol predetermination. The uplink resources corresponding to the two uplink transmission chains may be a same uplink resource (if the uplink resources corresponding to the two uplink transmission chains are a same uplink resource, the uplink transmission chain state is that the UE considers that two-port transmission occurs on the scheduled uplink carrier), or may be different uplink resources (that is, the UE should consider that one-port transmission occurs on the carrier scheduled by the first information and the determined another carrier).

What circumstances under which the uplink transmission chain state of the user equipment needs to be switched and what circumstances under which the uplink transmission chain state of the user equipment needs not to be switched may be predetermined through a protocol. Optionally, the rules in the existing communication standard protocols can be adopted. For example, in a time slot t2, the user equipment determines according to the first information that one uplink transmission chain is on an uplink carrier with an index of 1, the transmission mode is one-port transmission, and the uplink transmission chain state of the UE equipment in the time slot t1 (the time slot t1 is a preceding time slot before the time slot t2) is that two uplink transmission chains are on the uplink carrier with an index of 1. That is, the uplink carrier with an index of 1 is two-port transmission. At this time, it is unnecessary to switch the uplink transmission chain state of the user equipment.

In an optional embodiment of the present disclosure, if the first information schedules two uplink resources for one-port transmission or one uplink resource for two-port transmission, the UE may directly determine the current uplink transmission chain state of the UE according to the first information; and, if the first information schedules a first uplink resource and when the transmission mode is one-port transmission, when it is necessary to switch the uplink transmission, the UE needs to determine the transmission mode of the uplink resource of the user equipment according to the first information and at least one item in the second information.

Optionally, in embodiments of the present disclosure, the determining an uplink transmission chain state of the user equipment according to the first information may include:
determining an uplink transmission chain state of the user equipment according to the first information and at least one of the following:
higher-layer configuration; protocol predetermination; the capability of the user equipment; and, the preceding uplink transmission chain state of the user equipment;
wherein the higher-layer configuration includes information used for determining the uplink resource corresponding to the uplink transmission chain.

During the actual implementation process, if the first information transmitted by the base station indicates only one uplink resource (i.e., the first uplink resource) and the transmission mode is one-port transmission, the UE can know, according to the first in-formation, the uplink resource where one uplink transmission chain is located. In this case, the UE needs to further determine the uplink resource corresponding to another uplink transmission chain. Since the first uplink resource has been determined, when the uplink resource corresponding to another uplink transmission chain is determined, the transmission mode corresponding to the uplink resource for another uplink transmission chain is naturally known. For example, if the uplink resource corresponding to the another uplink transmission chain is the first uplink resource, the uplink transmission chain state of the UE is to perform two-port transmission on the first uplink resource; and, if the uplink resource corresponding to the another uplink transmission chain is not the first uplink resource, the uplink transmission chain state of the UE is to perform one-port transmission on two uplink resources, that is, one-port transmission is transmitted on two uplink resources.

Optionally, the UE may determine, according to one or more of the higher-layer configurations, the protocol predetermination, the capability of the user equipment and the preceding uplink transmission chain state of the user equipment, the uplink resource corresponding to another uplink transmission chain.

The higher-layer configuration includes information used for determining the uplink resource corresponding to the uplink transmission chain of the UE. The information may be information that can directly determine the uplink resource corresponding to another uplink transmission chain, or may be information that needs to be combined with other information to determine the uplink resource corresponding to another uplink transmission chain. For example, the higher-layer configuration may include in-formation used for determining whether the uplink resource corresponding to another uplink transmission chain is the first uplink resource. Thus, the UE can know, according to the higher-layer configuration, whether two uplink transmission chains are on a same uplink resource. If it is determined that two uplink transmission chains are on a same uplink resource, the UE can know the uplink resource corresponding to another uplink transmission chain according to the higher-layer configuration; and, if it is determined that two uplink transmission chains are not on a same uplink resource, the UE needs to further determine, in combination with other information, the uplink resource corresponding to another uplink transmission chain.

The protocol predetermination refers to the preconfigured or predetermined uplink resource determination/selection rule in the communication system. The UE can determine, according to the protocol predetermination or the combination of the protocol predetermination and other information, the uplink resource corresponding to another uplink transmission chain. For example, the pairing relationship between different uplink resources is predetermined through a protocol. After the UE determines the first uplink resource corresponding to one uplink transmission chain according to the first information, the UE can determine, according to the predetermined pairing relationship, the uplink resource paired with the first uplink resource as the uplink resource corresponding to another uplink transmission chain.

Optionally, in practical applications, the way of determining/selecting the uplink resource may also be predetermined or configured according to the capability of the UE. For example, different ways may be predetermined or configured according to different capabilities of the UE, so that the UE can adopt the corresponding way according to its own capability to determine the uplink resource corresponding to another uplink transmission chain.

In addition, the rule or requirement to be satisfied between the preceding transmission chain state of the user equipment and the transmission chain state to which the user equipment will be switched may also be predetermined or configured, for example, a switchover being allowed between which states, or a switchover being not allowed between which states. Thus, when the UE determines to perform state switching according to the first information, the UE can determine the uplink resource corresponding to another uplink transmission chain on the premise of satisfying the corresponding rule or requirement.

It should be understood that, in practical applications, if it is necessary to determine the uplink resource corresponding to another uplink transmission chain according to the higher-layer configuration, the method of the present disclosure further includes a step of acquiring the higher-layer configuration.

In an optional embodiment of the present disclosure, the determining an uplink transmission chain state of the user equipment according to the first information may include:
determining an uplink transmission chain state of the user equipment according to the first information and at least one item in the second information;
wherein the second information includes:
an index of each uplink resource of the user equipment;
priority information of each uplink resource of the user equipment;
an uplink resource that has performed uplink transmission most recently among uplink resources of the user equipment;
a pairing relationship among uplink resources of the user equipment;
a preceding uplink transmission chain state of the user equipment;
a switchover not allowed between different uplink transmission chain states;
a switchover allowed between different uplink transmission chain states;
a first configuration indicating whether two uplink transmission chains of the user equipment are located on a same uplink resource;
a second configuration indicating whether there are two uplink transmission chains on each uplink resource of the user equipment; and
capability information of the user equipment.

Optionally, one or more items in the above information may be configured through a higher layer signaling (i.e., configured through a higher layer) or predetermined through a protocol. In practical applications, determining the uplink transmission chain state of the user equipment may be implemented according to the first information and one or more items in the second information. That is, the multiple pieces of in-formation may be used alone or in combination.

For example, when the first uplink resource corresponding to one-port transmission may be determined according to the first information, the uplink resource where another transmission port (i.e., another uplink transmission chain) is located may be determined according to the size of the index of each uplink resource configured for the UE. For example, through the protocol predetermination or the higher-layer configuration, uplink resources for uplink transmission may be determined in an order from the largest to smallest (or smallest to largest) indexes of the uplink resources. For example, the uplink resource with the largest index among the uplink resources of the UE (or the uplink resources except for the first uplink resource) is determined as the uplink resource corresponding to another transmission port. Or, the priority of each source among L uplink resources of the UE may be configured through a higher-layer signaling. There may be uplink resources with the same priority among the L uplink resources, or the L uplink resources may have different priorities. If it is assumed that the protocol stipulates that the uplink resource with a higher priority is preferentially used as a resource where an uplink transmission chain is located, the UE may determine, according to the priority of each uplink resource, the uplink resource with the highest priority as the uplink resource where one-port transmission is located; or, when the UE determines according to the higher-layer signaling that the resource corresponding to another uplink transmission chain is not the first uplink resource, the UE may determine the uplink resource with the highest priority among the second uplink resources as the uplink resource where another uplink transmission chain is located. That is, the uplink resource where another uplink transmission chain is located considered by the UE may be determined in an order from the highest to lowest (or lowest to highest) priorities. For example, the uplink resource with the highest or lowest priority among the uplink resources of the UE (or the uplink resources except for the first uplink resource) is determined as the uplink resource corresponding to another transmission port.

Optionally, the uplink resource that has performed uplink transmission recently among uplink resources of the user equipment may be predetermined through a protocol or configured through a higher-layer signaling. The uplink resource that has performed uplink transmission recently or the uplink resource for uplink signal transmission among uplink resources of the user equipment (or uplink resources except for the first uplink resource) is used as the uplink resource corresponding to another uplink transmission chain.

Optionally, with regard to the pairing relationship among uplink resources of the user equipment, the pairing relationship among the uplink resources of the UE may be predetermined through a protocol or configured through a higher-layer signaling. When it is determined according to the first information that one-port transmission occurs on the first uplink resource, the uplink resource paired with the first uplink resource may be determined as the uplink resource corresponding to another uplink transmission chain.

The pairing relationship may be a binding relationship between two uplink resources, or may be a binding relationship of one uplink resource. The binding relationship of one uplink resource may be interpreted as the fact that two uplink transmission chains of the UE are located on this uplink resource, that is, two-port transmissions considered by the UE occur on this uplink resource. That is, the transmission mode corresponding to this uplink resource is two-port transmission. If it is assumed that the pairing relationship corresponding to the first uplink resource (which may be any uplink resource) among L uplink resources is the first uplink resource, when the first uplink resource is determined according to the first information and the transmission mode is one-port transmission, it can be determined according to the pairing relationship corresponding to the first uplink resource that the uplink resource corresponding to another uplink transmission chain is the first uplink resource, the first uplink resource is two-port transmission, and there is no transmission on other uplink resources.

Optionally, the pairing relationship may also be a correspondence relationship between uplink transmission resources corresponding to two uplink transmission chains directly configured through a higher-layer signaling configuration. Thus, after the first uplink resource for one-port transmission is determined according to the first information, the uplink resource (which may be the first uplink resource or other uplink resources) corresponding to another uplink transmission chain corresponding to the first uplink resource can be known according to the higher-layer signaling configuration. For example, the base station configures three uplink carriers (which are called carrier 1, carrier 2 and carrier 3 for convenience of description) for the UE. In a case where it is configured through the higher-layer signaling that the carrier 1 is one-port transmission, another uplink transmission chain is on the carrier 2; in a case where the carrier 2 is one-port transmission, another uplink transmission chain is on the carrier 3; and, in a case where the carrier 3 is one-port transmission, another uplink transmission chain is on the carrier 1. Thus, after the UE determines according to the first information that the uplink carrier corresponding to one uplink transmission chain is the carrier 1 (that is, the first information schedules the carrier 1 for one-port transmission), it can be determined that the uplink carrier corresponding to another uplink transmission chain is the carrier 2.

In embodiments of the present disclosure, with regard to the switchover allowed or not allowed between different uplink transmission chain states, considering that different UEs may have different capabilities or the implementation/configuration of switching between some states is too complicated, the switchover between uplink transmission chain states not allowed by the UE or the switchover between uplink transmission chain states allowed by the UE may be predetermined through a protocol or configured through a higher-layer signaling. Thus, during the determination of the current uplink transmission chain state, the UE needs to make the determination according to the rules for the switchover allowed and/or not allowed between transmission chain states.

In other words, the uplink resource corresponding to another uplink transmission chain may be determined according to the preceding uplink transmission chain state of the user equipment, the first uplink resource for one-port transmission already determined according to the first information and the switchover not allowed between different uplink transmission chain states; or. The switchover between different uplink transmission chain states allowed by user equipment with different capabilities may be predetermined or configured through a higher layer, and the UE may determine, according to its own capability and the preceding uplink transmission chain state, an uplink transmission chain state to which is currently allowed to be switched by the user equipment. If there is only one state to which is allowed to be switched, the state to which is allowed to be switched is the current uplink transmission chain state of the user equipment; and, if there are at least two states to which is allowed to be switched, the uplink resource corresponding to another uplink transmission chain may be further determined according to the protocol predetermination or the higher-layer configuration. For example, in the at least two states to which is allowed to be switched, the state to which the second uplink resource with a higher priority belongs may be determined as the current uplink transmission chain state of the user equipment.

Optionally, the first configuration or the second configuration may be configured through a higher-layer signaling. The names of the first configuration and the second configuration will not be limited to embodiments of the present disclosure. With regard to the first configuration, for each uplink resource among L uplink resources configured for the UE, it can be uniformly configured that the uplink carrier for transmitting uplink channels or uplink signals at one port is in two uplink transmission chains, or the uplink carrier for transmitting uplink channels or uplink signals at one port is in one uplink transmission chain while other uplink carriers are in another uplink chain, that is, whether two uplink transmission chains are on a same uplink resource. Optionally, during the actual implementation, the configuration may be performed through a higher-layer signaling. According to the configuration in-formation, the UE may know whether the uplink resource corresponding to another uplink transmission chain is the first uplink resource indicated by the first information, that is, whether two uplink transmission chains are on a same uplink resource.

With regard to the second configuration, for each uplink resource among L uplink resources configured for the UE, it can be separately configured that the uplink carrier for transmitting uplink channels or uplink signals at one port is in two uplink transmission chains, or the uplink carrier for transmitting uplink channels or uplink signals at one port is in one uplink transmission chain while the other uplink carrier is in another uplink transmission chain, that is, whether one uplink carrier corresponds to one uplink transmission chain or two uplink transmission chains. Optionally, with regard to the second configuration, during the actual implementation, the configurations for L uplink resources are separately realized through L separate high-layer signaling, wherein different uplink resources may have the same or different configurations. When the second configuration is adopted, after the UE determines the first uplink resource, the UE can know, according to the higher-layer configuration corresponding to the first uplink resource, whether the uplink corresponding to another uplink transmission chain is the first uplink resource indicated by the first information.

Optionally, the first configuration or the second configuration may be the configuration of the transmission state (TxState) of uplink switching of the user equipment. Optionally, the configuration may be configured by adopting the uplink-TxSwitching-DualUL-TxState higher-layer signaling in the existing standard protocols. Optionally, the configuration may be used to indicate whether two uplink transmission chains of the UE are on a same uplink carrier. For example, if the UE is configured with one-port/one-chain transmission (OneT), and when the UE is in an operating state where 2-port transmission can be supported on one uplink resource (e.g., carrier) in one frequency band, there is no transmission on any carrier in the same frequency band and 1-port transmission is supported on another carrier in another frequency band, the UE should consider that one-port transmission occurs on two uplink carriers, that is, 1-port transmission is transmitted on both uplink chains; or otherwise, the UE should consider 2-port transmission occurs on the transmission carrier, that is, two port transmissions occurs on one uplink carrier. In an optional embodiment of the present disclosure, if the UE is configured with OneT and when the first uplink resource for one-port transmission is determined according to the first in-formation (uplink resource scheduling information), it is determined that another transmission port occurs on another uplink resource different from the first uplink resource; or otherwise, two transmission ports both occur on the first uplink resource.

Optionally, when the UE is configured with more than two (e.g., 3) uplink resources and when the first uplink resource is determined as one-port transmission according to the first information, if the UE is configured with OneT, it can be further determined, according to one or more of the indexes and priorities of the listed uplink resources, that another uplink chain of the UE is on an uplink resource except for the first uplink resource. For example, if it is assumed that the indexes of three uplink carriers configured for the UE are 1, 2, and 3, respectively, it is determined according to the first information that the uplink carrier with an index of 1 is one-port transmission, OneT is configured through a higher-layer signaling and the protocol predetermines that the carrier where another uplink transmission chain is located is determined in an order from the largest to smallest indexes. Thus, another uplink transmission chain of the UE occurs on the uplink carrier with an index of 3.

In an optional embodiment of the present disclosure, the configuration of the transmission state (TxState) of uplink switching of the user equipment may be used to indicate whether two uplink transmission chains of the UE are on a same uplink carrier, and indicate that another uplink transmission chain is on which carrier when two uplink transmission chains of the UE are not on the same uplink carrier. That is, when the first uplink resource where one uplink transmission chain is located is determined, the UE can directly determine, according to the configuration, that another uplink transmission chain is on which uplink carrier. For example, the UE is configured with three uplink carriers, the indexes of the three uplink carriers are 1, 2, and 3, respectively, and it is determined according to the first information that the uplink resource with an index of 1 is one-port transmission. If the UE has received the configuration of OneT2, it can be determined according to the configuration that the uplink resource with an index of 2 is one-port transmission; and, if the UE has received the configuration of OneT3, it can be determined according to the configuration that the uplink resource with an index of 3 is one-port transmission. Optionally, if the UE has not received the configuration of TxState, it can be determined that the uplink resource with an index of 1 is two-port transmission.

Optionally, with regard to the capability information of the user equipment, according to different capabilities of UEs, the rule for determining uplink resources where uplink transmission chains corresponding to UEs with different capabilities can be predetermined through a protocol or configured through a higher-layer signaling. For example, for UEs with different capabilities, different uplink transmission chain states allowed for switching or uplink transmission chain states not allowed for switching can be configured. Thus, the UE can determine the uplink transmission chain state according to its own capability under the corresponding rule of allowing or not allowing switchover.

It is to be noted that, during the actual implementation, the higher-layer configuration may indicate at least one of the above. The specific indication mode may be explicit indication or implicit indication. By taking the pairing relationship as an example, the higher-layer signaling may include the explicit indication of the uplink resource corresponding to another uplink transmission chain corresponding to each uplink resource (for example, the carrier 1 corresponds to the carrier 2), or may be the rule between each uplink resource and the uplink resource corresponding to another uplink transmission chain corresponding to this uplink resource. For example, for each uplink resource, in a case where the uplink resource is one-port transmission, the uplink resource corresponding to another uplink transmission chain is an uplink resource having an index that is close to the index of this uplink resource and greater than the index of this uplink resource. By taking the above three uplink carriers as an example, if it is assumed that 1, 2, and 3 are the indexes of the three uplink carriers, respectively, the uplink resource determined according to the first information is the uplink resource with an index of 1 and the transmission mode is one-port transmission, the uplink resource with an index of 2 is the uplink resource corresponding to another uplink transmission chain.

During the configuration of one or more of the above of the UE through a higher-layer signaling, for L uplink resources, the uplink sources may be separately configured through a plurality of higher-layer signaling, or the L uplink resources are jointly configured through a higher-layer signaling.

In an optional embodiment of the present disclosure, the determining an uplink transmission chain state of the user equipment according to the first information includes:
determining, according to the first information, a first uplink resource for one-port transmission; and
if it is determined according to a higher-layer signaling configuration that another uplink transmission chain of the user equipment is not located on the first uplink resource, determining, according to at least one item in the second information, an uplink resource where the another uplink transmission chain is located.

In other words, when it can be known according to the first information that one uplink transmission chain is located on the first uplink resource, it can be known through the higher-layer signaling configuration whether two uplink transmission chains correspond to a same uplink resource. If it is determined to be the first uplink resource, the uplink transmission chain state of the user equipment is the two-port transmission of the first uplink resource; and, if it is determined to be not the first uplink resource, based on at least one item in the second information, the uplink resource corresponding to another uplink transmission chain is determined among the second uplink resources except for the first uplink resource in the uplink resources of the user equipment.

In this optional embodiment, based on the higher-layer signaling configuration, it can be determined whether the uplink resource corresponding to another uplink transmission chain is the first uplink resource. That is, the higher-layer signaling configuration may indicate whether two uplink transmission chains of the UE are located on a same uplink same. When it is determined according to the higher-layer signaling configuration that the uplink resource corresponding to another uplink transmission chain is not the first uplink resource, it can be further determined according to at least one item in the second information that the uplink resource corresponding to another uplink transmission chain is specifically which one of L-1 uplink resources. For example, according to the priorities of the L uplink resources, the carrier with the highest priority among the uplink carriers except for the first uplink resource can be used as the carrier where another uplink transmission chain is located; or, according to the indexes of the L uplink carriers, the uplink carrier with the largest or smallest index among the uplink carriers except for the first uplink resource can be used as the carrier where another uplink transmission chain is located.

During the actual implementation, the specific implementation of determining the uplink resource corresponding to another uplink transmission chain according to at least one of the above items may be configured through a higher-layer signaling, or may be predetermined through a protocol, or may be realized according to the higher-layer signaling configuration and the protocol predetermination.

For example, when the protocol predetermines that the uplink resources corresponding to two uplink transmission chains are different uplink resources, according to the size of the index of each second uplink resource, the second uplink source with the largest index can be selected as the uplink resource where another uplink transmission chain is located; or, when the protocol predetermines that the uplink resources corresponding to two uplink transmission chains are different uplink resources, according to the priority of each second uplink resource, the second uplink resource with the highest priority can be used as the uplink resource where another uplink transmission chain is located. Optionally, if there are at least two uplink resources with the highest priority, according to the protocol predetermination, the second uplink resource with the largest index in the at least two uplink resources can be determined as the uplink resource where another uplink transmission chain is located.

In an optional embodiment of the present disclosure, the determining an uplink transmission chain state of the user equipment according to the first information may include:
determining, according to the first information, a first uplink resource for one-port transmission; and
determining, according to the pairing relationship between the first uplink resource and each uplink resource of the user equipment, an uplink resource where another uplink transmission chain is located.

The configuration relationship may be the uplink resource matched with each uplink resource of the UE predetermined through the protocol or configured through a higher-layer signaling, or may be the uplink source where another uplink transmission chain occurs indicated by the configuration of the transmission state of uplink switching of the user equipment when each uplink resource is one-port transmission.

In other words, the uplink resource matched with each uplink resource in a case where each uplink resource is one-port transmission can be configured through a higher-layer signaling or predetermined through a protocol. That is, when it is determined according to the first information that the first uplink resource is one-port transmission, it can be determined according to the configuration or predetermination that the uplink resource matched with the first uplink resource is the uplink resource where another uplink chain is located.

It is to be noted that, the uplink resource matched with one uplink resource may be the uplink source itself or other uplink resources. For example, for an uplink carrier with an index of 1, the uplink resource matched with this carrier may be or may not be an uplink resource with 1 carrier.

In this optional solution, for each of the L uplink resources of the UE, when the uplink resource is a resource where one uplink transmission chain of the UE is located and the corresponding transmission mode is one-port transmission, it can be configured through a higher-layer signaling or predetermined/preconfigured through a protocol that the uplink resource where another uplink transmission chain is located is which uplink resource. When the UE has determined according to the first information transmitted by the base station that one uplink transmission chain corresponds to the first uplink resource and the transmission mode is one-port transmission, it can be determined according to the protocol predetermination or higher-layer signal configuration that another uplink chain is located on which one of the L uplink resources.

As another optional solution, the UE may determine, according to the configuration of the transmission state (TxState) of uplink switching of the user equipment, the uplink resource where another uplink transmission chain is located. The configuration may be configured through a higher-layer signaling. Optionally, when the UE has received the configuration, the UE may determine, according to the configuration, the resource where another uplink transmission chain is located; and, when the UE has not received the configuration, the UE may determine that two uplink transmission chains of the user equipment are located on the first uplink resource, that is, the first uplink resource is two-port transmission. In other words, if the UE has received the configuration, the UE should consider that one-port transmission occurs on two uplink resources; and, if the UE has not received the configuration, the UE should consider that two-port transmission occurs on two uplink resources.

Based on the optional solutions provided by the present disclosure, the base station can configure for the UE a plurality of uplink resources that can be used for uplink transmission, so that the UE can have more possible uplink transmission chain states. During the scheduling of resources of the UE, the base station can more flexibly schedule the uplink resources of the UE according to the usage of communication resources in the communication system. For example, the base station can schedule the UE according to the current communication condition of the network (e.g., the usage of communication resources of a plurality of UEs), so that the situation where different UEs occupy the same uplink resource is minimized. Accordingly, the problems such as failed uplink transmission and high transmission delay of the UE can be reduced, the communication effect of the UE can be better ensured, and the utilization of network resources can also be improved.

The above optional embodiments are described by taking a UE as the executive body of the method provided by the present disclosure. As illustrated in FIG. 4, the UE receives the first information from a base station, and the uplink transmission chain state of the UE is then determined according to the first information. Correspondingly, the method provided by the present disclosure can also be described by taking a base station as the executive body. That is, an embodiment of the present disclosure further provides a method performed by a base station in a communication system. The method may include the following actions of:
transmitting first information to a user equipment, the first information is configured to determine an uplink transmission chain state of the user equipment;
wherein the first information includes related information of a scheduled uplink resource and a transmission mode.

Optionally, the user equipment supports two uplink transmission chains, and the user equipment is configured with L uplink resources, where L≥2.

It should be understood that, the method is described by taking a base station as the executive body and is essentially the same as the method shown in FIG. 4; and, for the first information and the optional implementations of determining, by the UE, the transmission mode of the uplink resource of the UE according to the first information, reference may be made to the description in the foregoing embodiments, and details will not be repeated here.

Optionally, the method may further include: transmitting uplink resource configuration information to the user equipment, the configuration information configuring each uplink resource of the UE, for example, the number of uplink resources, the index of each uplink resource, the time-domain position or frequency-domain position of each uplink resource, etc. The UE may determine each configured uplink resource according to the configuration information.

Optionally, the method may further include: receiving at least one of an uplink channel and an uplink signal transmitted by the uplink resource and the transmission mode scheduled by the user equipment based on the first information. That is, after the UE determines, according to the first information transmitted by the base station, an uplink carrier on which the UE transmits an uplink channel or an uplink signal and the corresponding transmission mode, the UE may transmit an uplink channel or an uplink signal (e.g., uplink data, uplink control information, uplink reference signal, etc.) to the base station in the corresponding transmission mode according to the uplink carrier scheduled by the first information.

Optionally, the method may further include: transmitting a higher-layer configuration to the user equipment, the higher-layer configuration including information used for determining an uplink resource corresponding to an uplink transmission chain. The description of the higher-layer configuration may also refer to the corresponding description in the foregoing embodiments.

It is to be noted that, for a higher-layer configuration used for indicating or configuring different information, the base station may be configured through one piece of information/message/signaling, or may be configured through multiple pieces of in-formation/message/signaling. For example, the uplink transmission state of the UE may be configured through uplinkTxSwitching-DualUL-TxState, and the uplink resource of the UE may be configured through other higher-layer signaling.

To make the purposes, technical solutions, and advantages of the present disclosure clearer, the present disclosure will be further described below in detail by some specific optional embodiments.

In the optional embodiments described below, the uplink resource is an uplink carrier; the uplink transmission chain is an uplink chain; an uplink channel or an uplink reference signal may be transmitted on the uplink carrier; the uplink channel may include at least one of a PUSCH, a PUCCH or PRACH; and, the uplink reference signal includes, but not limited to, SRS. In the following optional embodiments, the granularity of the time unit in the time domain will be described by taking a time slot as an example. It should be understood that, during the time implementation, a time unit may also be a micro-time slot, or a time unit with other time granularities.

The method provided by the present disclosure may be used to transmit uplink channels and uplink reference signals, and the transmission mode for uplink channels or uplink reference signals may be one-port transmission or two-port transmission. This method may be implemented on the UE side. The UE supports two uplink transmission chains (TX chains), and the base station may be configured with L uplink carriers.

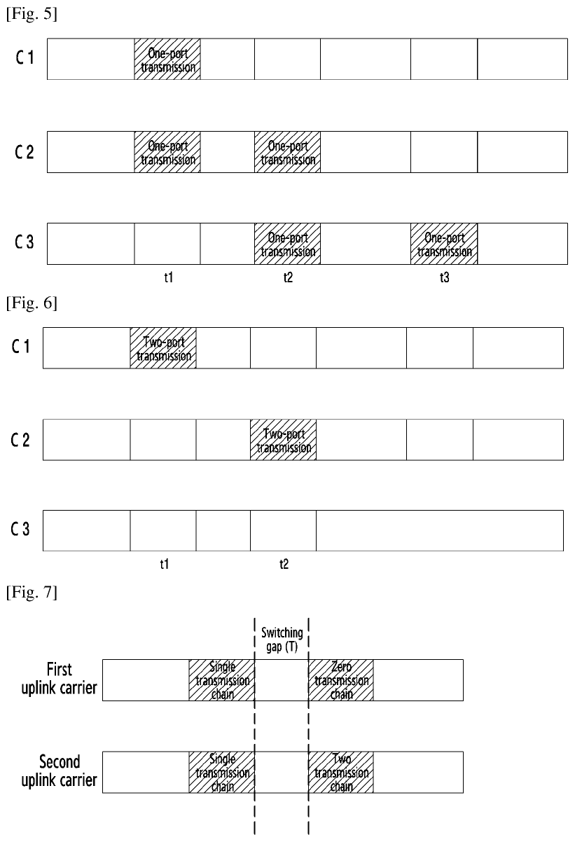

The UE may perform simultaneous transmission on at most N uplink carriers among the L configured uplink carriers at different times in a one-port transmission mode, where N may be 2. For example, L is equal to 3, the uplink carriers are C1, C2, and C3, respectively, and N is equal to 2. In a time slot t1, the UE may transmit an uplink channel on the uplink carriers C1 and C2 in the one-port transmission mode; in a time slot t2, the UE transmits an uplink channel on the uplink carriers C2 and C3 in the one-port transmission mode; and, in a time slot t3, the UE transmits an uplink channel on the uplink carrier C3 in the one-port transmission mode, as shown in FIG. 5.

The UE may also perform simultaneous transmission on at most M uplink carriers among the L configured uplink carriers at different times in a two-port transmission mode. For example, L is equal to 3, the uplink carriers are C1, C2, and C3, respectively, and M is equal to 1. In a time slot t1, the UE transmits an uplink channel on the uplink carrier C1 in the two-port transmission mode; and, in a time slot t2, the UE transmits an uplink channel on the uplink carrier C2 in the two-port transmission mode, as shown in FIG. 6.

When the UE is configured with two uplink carriers and if the UE has two uplink transmission chains, there may be three uplink transmission chain states. As shown in Table 1 below, the first uplink transmission chain state is that the first uplink carrier is in the transmission mode of a single transmission chain and the second uplink carrier is in the transmission mode of a single transmission chain (1T+1T). The second uplink transmission chain state is that the first uplink carrier is in the transmission mode of two transmission chains and the second uplink carrier is in the transmission mode of zero transmission chain (0T+2T). The third uplink transmission chain state is that the first uplink carrier is in the transmission mode of zero transmission chain and the second uplink carrier is in the transmission mode of two transmission chains (2T+0T). In each uplink transmission chain state, the combination of antenna ports for transmitting the uplink channel or uplink reference signal on two uplink carriers is shown in the rightmost column of Table 1. The uplink carrier in the transmission mode of a single transmission chain may be in one-port transmission (1P) or zero-port transmission (0P), and the uplink carrier in the transmission mode of two transmission chains may be in two-port transmission (2P) or one-port transmission (1P).

It can be known from the above description that the uplink transmission state in embodiments of the present disclosure refers to the uplink resource where two ports considered by the UE is located. For example, for the chain state of 1T+1T in Table 1, the UE considers that the one-port transmission/transmit occurs on the first uplink carrier and the second uplink carrier; and, for 0T+2T, UE should consider that the two-port transmission occurs on the second uplink carrier. Similarly, the second column in Table 2 below has the similar meaning. For example, for the chain state of 1T+1T+0T, the UE considers that the one-port transmission/transmit occurs on the first uplink carrier and the second uplink carrier; and, for 2T+0T+0T, the UE considers that the two-port transmission/transmit occurs on the first uplink carrier.

TABLE 1

| | | The number of | Transmission |
|---|---|---|---|
| | | transmission chains | antenna ports (the |
| | | (the first uplink | first uplink carrier + |
| | | carrier + the second | the second |
| | | uplink carrier) | uplink carrier) |
| First | uplink | 1T + 1T | 1P + 0P, 1P + 1P, |
| transmission | chain | | 0P + 1P |
| state | | | |
| Second | uplink | 0T + 2T | 0P+2P, 0P+1P |
| transmission | chain | | |
| state | | | |
| Third | uplink | 2T + 0T | 2P + 0P, 1P + 0P |
| transmission | chain | | |
| state | | | |

Above table 1 describes a correspondence among the uplink transmission chain states, the number of transmission chains and the transmission antenna ports.

A switching gap is required for switching from one uplink transmission chain state to another uplink transmission chain state. In the switching gap, the UE may not transmit the uplink channel and the uplink reference signal. For example, when the UE is switched from the first uplink transmission chain state (1T+1T) to the second uplink transmission chain state (0T+2T), a switching gap with a duration of T is required, as shown in FIG. 7. In the period of time T, the UE may not transmit the uplink channel and the uplink reference signal.

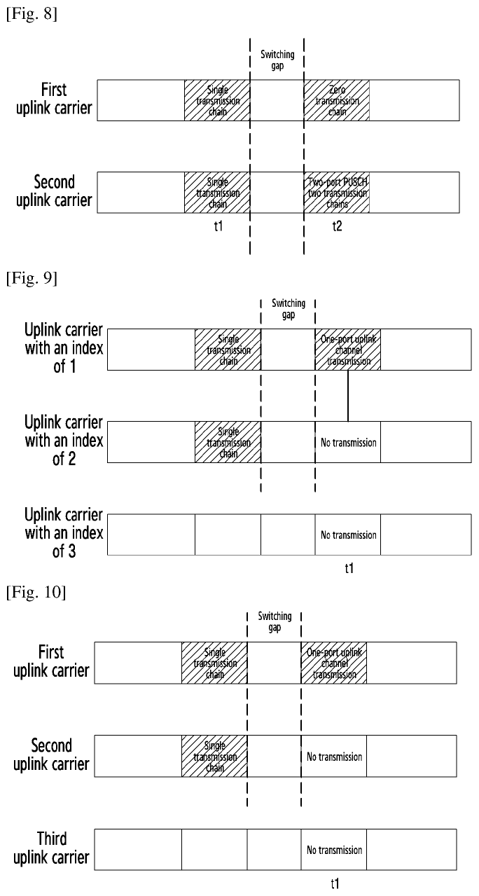

The switching of the uplink transmission chain state may be driven by the transmission of the scheduled or configured uplink channel/uplink reference signal. For example, the UE is configured with two uplink carriers. The UE is in the first uplink transmission chain state (1T+1T) in the time unit t1, the base station schedules the UE in the time unit 2 to transmit a PUSCH at two ports on the second uplink carrier, and the two uplink transmission chains are on the second uplink carrier. At this time, the UE will be switched to the second uplink transmission chain state (0T+2T), as shown in FIG. 8.

The above description shows the switching method for uplink transmission chain states and uplink transmission chains in a case where the UE is configured with two uplink carriers. In a case where the UE supports two uplink transmission chains, the base station may configure more than two uplink carriers (for example, the base station may configure three or four uplink carriers). At the same moment, the UE may use two uplink transmission chains to transmit an uplink channel or uplink reference signal on at most two uplink carriers. At different moments, UE may transmit an uplink channel or uplink reference signal on at most two different uplink carriers.

When the UE is configured with more than two uplink carriers, in a case where the UE may use two uplink transmission chains to transmit an uplink channel or uplink reference signal on at most two uplink carries at the same moment, the switching method for different uplink transmission chain states when the uplink transmission chain state is switched will be described below by some optional embodiments.

When the UE has received the configuration information from the base station and the base station configures L uplink carriers for the UE, the UE may simultaneously transmit, on at most N uplink carriers, the uplink channel or uplink reference signal on at most N uplink carriers among the L configured carriers in a one-port transmission mode at different moments, or simultaneously transmit, on at most M uplink carriers, the uplink channel or uplink reference signal on at most M uplink carriers among the L configured carriers in a two-port transmission mode at different moments. At different moments, the UE may be switched between different uplink transmission chain states. The method of determining the uplink transmission chain state after switching will be described below.

### Example 1

When the UE is configured with three uplink carriers and the UE has two uplink transmission chains, there may be at most six uplink transmission chain states. The six uplink transmission chain states may be classified into two categories. One category is that two uplink transmission chains are located on two uplink carriers among the three uplink carriers and the two uplink carriers correspond to one-port transmission. That is, two uplink carriers among the three uplink carriers are in the transmission mode of a single transmission chain, while the other uplink carrier is in the transmission mode of zero transmission chain. The other category is that two uplink transmission chains are located on one uplink carrier among the three uplink carriers. That is, one uplink carrier among the three uplink carriers is in the transmission mode of a single transmission chain, while the other two uplink carriers are in the transmission mode of zero transmission chain. The six uplink transmission chain states will be described below.

The first uplink transmission chain state is that the first uplink carrier is in the transmission mode of a single transmission chain, the second uplink carrier is in the transmission mode of a single transmission chain and the third uplink carrier is in the transmission mode of zero transmission chain.

The second uplink transmission chain state is that the first uplink carrier is in the transmission mode of a single transmission chain, the second uplink carrier is in the transmission mode of zero transmission chain and the third uplink carrier is in the transmission mode of a single transmission chain.

The third uplink transmission chain state is that the first uplink carrier is in the transmission mode of zero transmission chain, the second uplink carrier is in the transmission mode of a single transmission chain and the third uplink carrier is in the transmission mode of a single transmission chain.

The fourth uplink transmission chain state is that the first uplink carrier is in the transmission mode of zero transmission chain, the second uplink carrier is in the transmission mode of two transmission chains and the third uplink carrier is in the transmission mode of zero transmission chain.

The fifth uplink transmission chain state is that the first uplink carrier is in the transmission mode of two transmission chains, the second uplink carrier is in the transmission mode of zero transmission chain and the third uplink carrier is in the transmission mode of zero transmission chain.

The sixth uplink transmission chain state is that the first uplink carrier is in the transmission mode of zero transmission chain, the second uplink carrier is in the transmission mode of zero transmission chain and the third uplink carrier is in the transmission mode of two transmission chains.

It is to be noted that, in the above description of the transmission chain states, the “first”, “second” and “third” in the first uplink carrier, the second uplink carrier, and the third uplink carrier are merely used to distinguish the three uplink carriers so as to facilitate the explanation and understanding of the solutions, and should not be construed as other limitations to the three carriers.

In each uplink transmission chain state, the combination of antenna ports for transmitting the uplink channel or uplink reference signal on the three configured uplink carriers may refer to Table 2. The uplink carrier in the transmission mode of a single transmission chain may be in one-port transmission (1P) or zero-port transmission (0P), and the uplink carrier in the transmission mode of two transmission chains may be in two-port transmission (2P) or one-port transmission (1P).

TABLE 2

| | | The number of | |
|---|---|---|---|
| | | transmission | |
| | | chains (the first | Transmission |
| | | uplink carrier + | antenna ports (the |
| | | the second | first uplink carrier + |
| | | uplink carrier + | the second uplink |
| | | the third uplink | carrier + the third |
| | | carrier) | uplink carrier) |
| First | uplink | 1T + 1T + 0T | [symbol] , |
| transmission | chain | | 1P + 1P + 0P, |
| state | | | [symbol] |
| Second | uplink | 1T + 0T + 1T | [symbol] , |
| transmission | chain | | 1P + 0P + 1P, |
| state | | | [symbol] |
| Third | uplink | 0T + 1T + 1T | [symbol] , |
| transmission | chain | | 0P + 1P + 1P, |
| state | | | [symbol] |
| Fourth | uplink | 0T + 2T + 0T | 0P + 2P + 0P, |
| transmission | chain | | [symbol] |
| statc | | | |
| Fifth | uplink | 2T + 0T + 0T | 2P + 0P + 0P, |
| transmission | chain | | [symbol] |
| state | | | |
| Sixth | uplink | 0T + 0T + 2T | 0P + 0P + 2P, |
| transmission | chain | | [symbol] |
| state | | | |

Above table 2 describes a correspondence among the uplink transmission chain states, the number of transmission chains and the transmission antenna ports.

It can be known from Table 2 that, in different uplink transmission chain states, there are combinations of transmission of uplink channels or uplink reference signals at the same transmission antenna port. The combination of one-port transmission on one uplink carrier and no port transmission on the other two uplink carriers may be one of multiple different uplink transmission chain states. For example, with reference to the combination 1P+0P+0P of transmission of uplink channels or uplink reference signals at the transmission antenna port marked by the bold rectangular box, there is one-port transmission of the uplink channel or uplink reference signal on the first uplink carrier, and there are no transmission of the uplink channel or uplink reference signal on the second uplink carrier and the third uplink carrier. For this combination, at this time, the uplink transmission chain state may be one of the first uplink transmission chain state, the second uplink transmission chain state, and the fifth uplink transmission chain state. Or, with reference to the combination 0P+1P+0P of transmission of uplink channels or uplink reference signals at the transmission antenna port marked by the ellipse, there is one-port transmission of the uplink channel or uplink reference signal on the second uplink carrier, and there are no transmission of the uplink channel or uplink reference signal on the first uplink carrier and the third uplink carrier. At this time, the uplink transmission chain state may be one of the first uplink transmission chain state, the third uplink transmission chain state, and the fourth uplink transmission chain state. Or, with reference to the combination 0P+0P+1P of transmission of uplink channels or uplink reference signals at the transmission antenna port marked by the thin rectangular box, there is one-port transmission of the uplink channel or uplink reference signal on the third uplink carrier, and there are no transmission of the uplink channel or uplink reference signal on the first uplink carrier and the second uplink carrier. At this time, the uplink transmission chain state may be one of the second uplink transmission chain state, the third uplink transmission chain state and the sixth uplink transmission chain state.

As can be known, when the UE determines, according to the first information received from the base station, the uplink carrier where one uplink transmission chain is located and the transmission mode is one-port transmission, when the UE is configured with a plurality of uplink carriers, the specific uplink transmission chain state may be determined by the following method since some port combinations will correspond to multiple uplink transmission chain states, as shown in Table 2.

### Optional Embodiment 1

For the combinations of transmission ports corresponding to multiple uplink transmission chain states, for example, the above port combinations “1P+0P+0P”, “0P+1P+0P” and “0P+0P+1P”, since one uplink carrier among the three uplink carriers is one-port transmission (that is, one uplink transmission chain is located on this uplink carrier), if this uplink carrier supports the two-port transmission mode, the UE may determine, by receiving a signaling (e.g., higher-layer signaling configuration), whether another uplink transmission chain is also located on this uplink carrier or on other uplink carriers. If it can be determined according to the configuration of the signaling that another uplink transmission chain is also located on this uplink carrier, it can be determined that two uplink transmission chains are located on this uplink carrier, that is, this carrier is in the two-port transmission mode.

For example, for the port combination 1P+0P+0P, since the first uplink carrier transmits the uplink channel or uplink reference signal at one port, one uplink transmission chain is located on the first uplink carrier. If the first uplink carrier supports the two-port transmission mode, the UE may determine, by receiving a signaling (e.g., higher-layer signaling configuration), whether another uplink chain is located on the first uplink carrier or other uplink carriers. If the UE determines, by receiving the signaling, that another uplink chain is located on the first uplink carrier, the UE is in the two-port transmission mode on the first uplink carrier, and the UE is in the fifth uplink transmission chain state.

For the port combination 0P+1P+0P, since the second uplink carrier transmits the uplink channel or uplink reference signal at one port, one uplink transmission chain is located on the second uplink carrier. If the second uplink carrier supports the two-port transmission mode, the UE may determine, by receiving a signaling (e.g., higher-layer signaling configuration), whether another uplink chain is located on the second uplink carrier or other uplink carriers. If the UE determines, by receiving the signaling (e.g., higher-layer signaling configuration), that another uplink chain is located on the second uplink carrier, the UE is in the two-port transmission mode on the second uplink carrier, and the UE is in the fourth uplink transmission chain state.

For the port combination 0P+0P+1P, since the third uplink carrier transmits the uplink channel or uplink reference signal at one port, one uplink transmission chain is located on the third uplink carrier. If the third uplink carrier supports the two-port transmission mode, the UE may determine, by receiving a signaling (e.g., higher-layer signaling configuration), whether another uplink chain is located on the third uplink carrier or other uplink carriers. If the UE determines, by receiving the signaling (e.g., higher-layer signaling configuration), that another uplink chain is located on the third uplink carrier, the UE is in the two-port transmission mode on the third uplink carrier, and the UE is in the sixth uplink transmission chain state.

For the uplink carriers that transmit an uplink channel or uplink reference signal at one port, for example, when the UE is configured with three uplink carriers, the port combinations “1P+0P+0P”, “0P+1P+0P” and “0P+0P+1P” correspond to the following three situations, respectively: the first uplink carrier corresponds to one-port transmission, the second uplink carrier corresponds to one-port transmission, and the third uplink carrier corresponds to one-port transmission. Optionally, it is possible to jointly configure, through a higher-layer signaling, that the uplink carrier that transmits an uplink channel or uplink reference signal at one port is located on two uplink chains, or the uplink carrier that transmits an uplink channel or uplink reference signal at one port is located on one uplink carrier while other uplink carriers are located on another uplink chain. Optionally, it is also possible to separately configure, through three separate higher-layer signaling, that the uplink carrier that transmits an uplink channel or uplink reference signal at one port is located on two uplink chains, or the uplink carrier that transmits an uplink channel or uplink reference signal at one port is located on one uplink carrier while other uplink carriers are located on another uplink chain. That is, for each uplink carrier, it can be configured that this uplink carrier is located on two uplink transmission chains, or this uplink carrier is located on one uplink transmission chains while other carriers are located on another uplink transmission chain, when this uplink carrier corresponds to the one-port transmission mode.

As an alternative, it is possible to indicate through uplinkTxSwitching-DualUL-TxState whether two uplink transmission chains of the UE are located on a same uplink carrier. For example, if the UE is configured with OneT, it indicates that two uplink transmission chains are located on two different uplink carriers; and, if the UE is not configured with OneT, it can be considered that two uplink transmission chains are located on the same uplink carrier.

In a case of determining that one uplink transmission chain is located on one uplink carrier, if the UE determines according to the received signaling that another uplink transmission chain is also located on the same uplink carrier, the uplink transmission chain state of the UE can be determined; and, if the UE determines according to the received signaling that another uplink chain is located on other uplink carriers, the uplink transmission chain state can be determined in the following ways.

### Way 1

It is predetermined or preconfigured (e.g., by higher-layer signaling configuration) that the carrier where another uplink transmission chain is located is selected according to the indexes of the uplink carriers. Optionally, in an order from the largest to smallest (or smallest to largest) indexes of the uplink carriers, an uplink carrier except for the uplink carrier that transmits the uplink channel at one-port is selected as the uplink carrier for transmission on another uplink chain.

It should be understood that the index of the carrier is an identifier form of the carrier. During the actual implementation, if the carrier has other identifier forms, the way of selecting the uplink carrier corresponding to another uplink transmission chain may be predetermined or preconfigured through a protocol according to other identifier forms of the carrier. Correspondingly, the UE may determine, according to the identifier of the corresponding form of each uplink carrier configured by the base station, the carrier where another uplink transmission chain is located.

For example, it is predetermined/predefined that the carrier with a larger index is selected as the uplink carrier where another uplink transmission chain is located in an order from the largest to smallest indexes of the uplink carriers. If the UE is configured with three uplink carriers having indexes of 1, 2, and 3, as shown in FIG. 9, in a time slot t1, the UE determines according to the scheduling information transmitted by the base station that there is one-port transmission of the uplink channel on the uplink carrier with an uplink carrier index of 1 and there is no transmission on the uplink carriers with indexes of 2 and 3. If an uplink carrier with an uplink carrier index of 3 except for the uplink carrier that transmits the uplink channel at one port and has an index of 1 is selected as the uplink carrier for transmission on another uplink chain in an order of from the largest to smallest indexes of the carriers according to the predetermination, two uplink chains of the UE are located on the uplink carrier with an index of 1 and the uplink carrier with an index of 3, respectively, and the UE is in the second uplink transmission chain state.

### Way 2

It is predetermined or preconfigured (e.g., higher-layer signaling configuration) that the carrier where another uplink transmission chain is selected according to the priorities of the uplink carriers. Optionally, in an order from the highest to lowest priorities of the uplink carriers, an uplink carrier except for the uplink carrier that transmits the uplink channel at one port is selected as the uplink carrier for transmission on another uplink chain. That is, an uplink carrier with a higher priority is preferentially selected as the uplink carrier where another transmission chain is located. The priority of each uplink carrier may be configured through a signaling (e.g., higher-layer signaling).

For example, the UE is configured with three uplink carriers, and the priorities of the uplink carriers are sorted as follows: the priority of the first uplink carrier is the highest, the priority of the second uplink carrier is the second highest, and the priority of the third uplink carrier is the lowest. As shown in FIG. 10, in a time slot t1, there is one-port transmission of the uplink channel on the first uplink carrier. If a third uplink carrier except for the first uplink carrier that transmits the uplink channel at one port is selected as the uplink carrier for transmission on another uplink chain in an order from the highest to smallest priorities of the uplink carriers, two uplink chains of the UE are located on the first uplink carrier and the third uplink carrier, respectively, and the UE is in the second uplink transmission chain state.

### Way 3

It is predetermined or preconfigured (e.g., higher-layer signaling configuration) that the uplink carrier corresponding to another uplink transmission chain is selected according to the time of uplink transmission in the uplink carrier. Optionally, an uplink carrier except for the uplink carrier that transmits the uplink channel at one port may be selected as the uplink carrier for transmission on another uplink chain in an order from the smallest to largest distance (from the smallest to largest time difference with the current time) of the transmission of the uplink channel or uplink reference signal in the uplink carrier. For example, an uplink carrier that has transmitted the uplink channel or uplink reference signal in the most recent time is used as the uplink carrier where another uplink transmission chain is located.

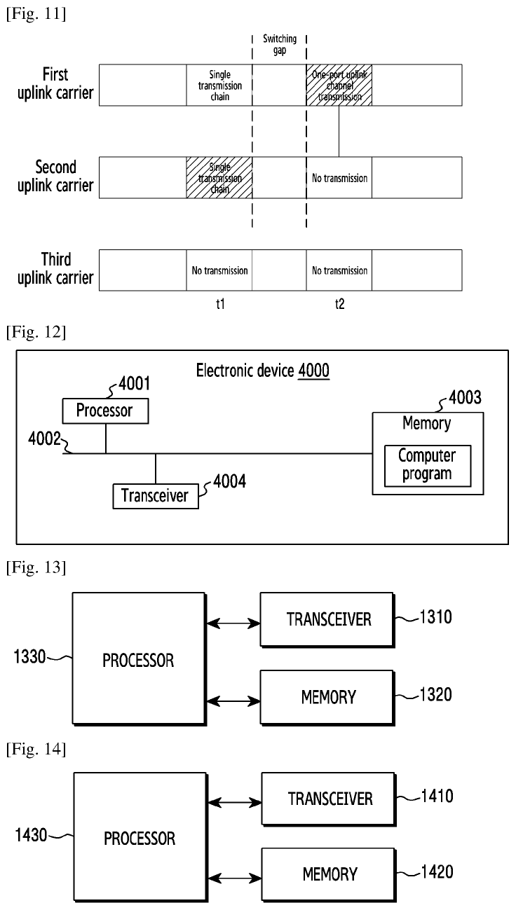

For example, the UE is configured with three uplink carriers. As shown in FIG. 11, in a time slot t2, there is one-port transmission of the uplink channel on the first uplink transmission, and the uplink transmission closest to the time slot t2 on other two uplink carriers except for the first uplink carrier is the transmission of the uplink channel on the second uplink carrier in a time slot t1. That is, for the second uplink carrier and the third uplink carrier, the uplink carrier that has performed uplink transmission in the most recent time (closest to the time slot t1) in the two uplink carriers before the time slot t1 is the second uplink carrier. If a second uplink carrier except for the first uplink carrier that transmits the uplink channel at one port is selected as the uplink carrier for transmission on another uplink chain in an order from the smallest to largest distance of the transmission of the uplink channel or uplink reference signal in the uplink carrier, two uplink chains of the UE are located on the first uplink carrier and the second uplink carrier, respectively, and the UE is in the first uplink transmission chain state.

### Way 4

The uplink carrier corresponding to another uplink transmission chain may be determined by combining two or three of the above ways 1, 2, and 3. Optionally, the determination may be performed first in one of the three ways. If at least two uplink carriers are determined in one way (when the UE is configured with three uplink carriers, at most two uplink carriers are determined; and, if the UE is configured with four or more carriers, more than two uplink carriers may be determined), the uplink carrier where another uplink transmission chain is located may be further determined in one or more of the other two ways. For example, the determination is performed first in the way 3. If at least two uplink carriers are determined in the way 3, the uplink carrier where another uplink transmission chain is located may be further determined from the at least two determined uplink carriers according to the indexes or priorities of the carriers in at least one of the way 1 or way 2.

As an optional implementation, an uplink carrier except for the uplink carrier that transmits the uplink channel at one port may be first selected as the uplink carrier for transmission on another uplink chain in an order from the smallest to largest distance of the transmission of the uplink channel or uplink reference signal in the uplink carrier. If it is impossible to select an uplink carrier except for the uplink carrier that transmits the uplink channel at one port as the uplink carrier for transmission on another uplink chain in the order from the smallest to largest distance of the transmission of the uplink channel or uplink reference signal in the uplink carrier, an uplink carrier except for the uplink carrier that transmits the uplink channel at one port may be selected as the uplink carrier for transmission on another uplink chain in an order from the highest to lowest priority of the uplink carrier, or an uplink carrier except for the uplink carrier that transmits the uplink channel at one port may be selected as the uplink carrier for transmission on another uplink chain in an order from the largest to smallest (or smallest to largest) index of the uplink carrier.

For example, the UE is configured with three uplink carriers. In a time slot t2, there is one-port transmission of the uplink channel on the first uplink carrier, and the uplink transmission closest to the time slot t1 on other two uplink carriers except for the first uplink carrier is the transmission of the uplink channel on the second uplink carrier and the transmission of the uplink channel on the third uplink carrier in the time slot t1. At this time, it is impossible to select the second or third uplink carrier except for the uplink carrier that transmits the uplink channel at one port as the uplink carrier for transmission on another uplink chain in the order from the smallest to largest distance of the transmission of the uplink channel or uplink reference signal in the uplink carrier. Then, an uplink carrier with an uplink carrier index of 3 except for the uplink carrier that transmits the uplink channel at one port and has an index of 1 may be selected as the uplink carrier for transmission on another uplink chain in an order from the largest to smallest index of the carrier. Two uplink chains of the UE are located on the first uplink carrier and the third uplink carrier, respectively, and the UE is in the second uplink transmission chain state.

### Way 5

Another uplink carrier paired with the uplink carrier that transmits the uplink channel at one port can be determined as the uplink carrier for transmission on another uplink chain according to the higher-layer signaling configuration or protocol predetermination. That is, the pairing relationship among uplink carriers can be configured through a higher-layer signaling (or predetermined through a protocol). When the UE has determined the uplink carrier corresponding to one uplink carrier chain according to the received scheduling information, the UE can determine the uplink carrier corresponding to another uplink transmission chain according to the pairing relationship configured through a higher layer or predetermined through a protocol.

For example, the UE is configured with three uplink carriers. The UE receives a higher-layer signaling configuration, and knows according to the configuration that another uplink carrier paired with the first uplink carrier that transmits the uplink channel at one port is the second uplink carrier, another uplink carrier paired with the second uplink carrier that transits the uplink channel at one port is the first uplink carrier and another uplink carrier paired with the third uplink carrier that transmits the uplink channel at one port is the first uplink carrier. That is, it is configured through the higher-layer signaling that each uplink carrier of the UE corresponds to one carrier paired with this uplink carrier in the time domain of one-port transmission (this carrier may be this uplink carrier, or may be one of two uplink carriers except for this uplink carrier). Thus, in a time slot t1, if the UE has determined according to the scheduling information that there is one-port transmission of the uplink channel on the first uplink carrier, according to the pairing relationship, another uplink carrier paired with the first uplink carrier that transmits the uplink channel at one port is the second uplink carrier, and the UE is in the first uplink transmission chain state. In a time slot t2, if the UE has determined according to the scheduling information that there is one-port transmission of the uplink channel on the third uplink carrier, another uplink carrier paired with the third uplink carrier that transmits the uplink channel at one port is the first uplink carrier, and the UE is in the second uplink transmission chain state.

For another example, the UE is configured with three uplink carriers, and the pairing relationship among the three uplink carriers is predetermined by a protocol. For example, the pairing relationship is predetermined according to the size of the index. Another uplink carrier paired with one uplink carrier that transmits the uplink channel at one port is an uplink carrier that has an index close to the first index of the uplink carrier that transmits the uplink channel at one port and less than the first index after the indexes of the uplink carriers are sorted from largest to smallest (or from smallest to largest). If the first index is the smallest index among the indexes of the three carriers, the uplink carrier that transmits the uplink channel at one port is the uplink carrier corresponding to the largest index among the indexes of the three uplink carriers.

It is assumed that the indexes of the three uplink carriers of the UE are 1, 2, and 3, respectively, the carrier with an index of 1 is called the first carrier, the carrier with an index of 2 is called the second carrier, and the carrier with an index of 3 is called the third carrier. Thus, in a time slot 1, if the UE has determined according to the scheduling information that there is one-port transmission of the uplink channel on the uplink carrier with an index of 2, according to the pairing relationship, another uplink carrier paired with the uplink carrier with an index of 2 is the uplink carrier with an index of 1, and the UE is in the first uplink transmission chain state. In a time slot 1, if the UE has determined according to the scheduling information that there is one-port transmission of the uplink channel on the uplink carrier with an index of 1, another uplink carrier paired with the uplink carrier with an index of 1 is the uplink carrier with an index of 3, and the UE is in the second uplink transmission chain state.

### Way 6

According to the protocol or higher-layer signaling configuration or UE's capability, it can be determined that the switchover between some uplink transmission chain states is not allowed. During the determination of the uplink carrier where another uplink transmission chain is located, the uplink transmission chain states to which cannot be switched are excluded first, and an uplink transmission chain state to which is to be switched is determined from the uplink transmission chain states to which can be switched.

For example, in a time slot t1, the UE is in the fourth uplink transmission chain state (0T+2T+0T). This state is a preceding uplink transmission chain state corresponding to the time slot t2. In the time slot t2, the UE determines according to the scheduling in-formation that there is one-port transmission of the uplink channel on the first uplink carrier and there is no transmission on the other two uplink carriers. That is, the port combination is 1P+0P+0P. When it is determined to switch the uplink transmission chain state of the UE, the possible uplink transmission chain states to which the port combination of 1P+0P+0P is to be switched are the first uplink transmission chain state (1T+1T+0T), the second uplink transmission chain state (1T+0T+1T) and the fifth uplink transmission chain state (2T+0T+0T). If the switchover from the fourth uplink transmission chain state to the second uplink transmission chain state is an uplink chain state switchover that is not allowed, the uplink transmission chain state to which is to be switched is the first uplink transmission chain state (1T+1T+0T) or the fifth uplink transmission state (2T+0T+0T). The uplink transmission chain state to which is specifically switched being the first uplink transmission chain state (1T+1T+0T) or the fifth uplink transmission state (2T+0T+0T) may be further determined in the above way.

### Way 7

According to the protocol or higher-layer signaling configuration or UE's capability, it can be determined that the switchover between some uplink transmission chain states is allowed. Optionally, if the uplink carrier that transmits an uplink channel or uplink reference signal at one port may correspond to at least one uplink transmission chain state to which is allowed to be switched, during the determination of the uplink carrier where another uplink transmission chain is located, the uplink transmission chain state to which can be switched currently can be determined from the stipulated uplink transmission chain states to which are allowed to be switched. If only one chain state is determined, the determined chain state is the uplink transmission chain state to which is to be switched currently; and, if at least two uplink transmission chain states are determined, the uplink transmission chain state may be determined in other ways described above.

### Optional Embodiment 2

For the combinations of transmission ports corresponding to multiple uplink transmission chain states, for example, the port combinations “1P+0P+0P”, “0P+1P+0P” and “0P+0P+1P”, since one uplink carrier among the three uplink carrier is one-port transmission (that is, one uplink transmission chain is located on this uplink carrier), if this uplink carrier supports the two-port transmission mode, the UE may determine, by receiving a signaling (e.g., higher-layer signaling configuration) or according to the protocol predetermination, that another uplink transmission chain is located on which uplink carrier.

Optionally, the uplink carrier where another uplink transmission chain is located when each carrier among the three uplink carriers of the UE transmits an uplink channel or signal at one port may be configured through a higher-layer signaling. For example, the UE is configured with three uplink carriers having indexes of 1, 2 and 3. For the three carriers, through a higher-layer signaling uplinkTxSwitching-DualUL-TxState, an indication of OneT2 is configured for the uplink carrier with an index of 1, an indication of OneT3 is configured for the uplink carrier with an index of 2, and an indication of OneT1 is configured for the uplink carrier with an index of 2, wherein the OneT2 indicates that another uplink transmission chain is located on the carrier with an index of 2 when the carrier with an index of 1 is in one-port transmission, the OneT3 indicates that another uplink transmission chain is located on the carrier with an index of 3 when the carrier with an index of 2 is in one-port transmission, and the OneT1 indicates that another uplink transmission chain is located on the carrier with an index of 1 when the carrier with an index of 3 is in one-port transmission.

Optionally, the uplink carrier matched with each uplink carrier when this uplink carrier is in one-port transmission can be configured through a higher-layer signaling, and the UE can determine, according to the matching relationship, the carrier where another uplink transmission chain is located.

Optionally, when each uplink carrier transmits an uplink channel or signal at one port, the pairing relationship between the uplink carrier where another uplink chain and this carrier or the condition to be satisfied can be predetermined through a protocol. For example, when one uplink carrier transmits an uplink channel or signal at one port, it can be predetermined through a protocol that the uplink carrier where another uplink carrier chain is located may be an uplink carrier with an index adjacent to (closest to) the index of this carrier among the indexes greater than (or less than) the index of this carrier. If the index of this carrier is the largest index among the indexes of the three uplink carriers, another uplink carrier corresponding to this carrier is the carrier with the smallest index. For example, the indexes of the three uplink carriers are 1, 2, and 3, respectively. In the time slot t1, the UE determines according to the scheduling in-formation that the uplink carrier with an index of 1 is in one-port transmission, and according to the protocol predetermination, the index 2 is the index closest to the index 1 among the indexes greater than the index 1. Therefore, the uplink carrier with an index of 2 is the carrier where another uplink transmission chain is located. In the time slot t2, the UE determines according to the scheduling information that the uplink carrier with an index of 3 is in one-port transmission, and according to the protocol predetermination, the carrier with an index of 1 is the carrier corresponding to another uplink transmission chain.

As an example, for the transmission port combination 1P+0P+0P marked by the bold rectangular box in Table 2, since the first uplink carrier transmits the uplink channel or uplink reference signal at one port, one uplink transmission chain is located on the first uplink carrier. If the first uplink carrier supports the two-port transmission mode, the UE may determine, by receiving a signaling (e.g., higher-layer signaling configuration), whether another uplink chain is located on the first uplink carrier, the second uplink carrier or the third uplink carrier. If the UE determines, by receiving the signaling (e.g., higher-layer signaling configuration), that another uplink chain is located on the first uplink carrier, two uplink transmission chains of the UE are located on the first uplink carrier, and the UE is in the fifth uplink transmission chain state. If the UE determines, by receiving the signaling (e.g., higher-layer signaling configuration), that another uplink chain is located on the second uplink carrier, two uplink transmission chains of the UE are located on the first uplink carrier and the second uplink carrier, respectively, and the UE is in the first uplink transmission chain state. If the UE determines, by receiving the signaling (e.g., higher-layer signaling configuration), that another uplink chain is located on the third uplink carrier, two uplink transmission chains of the UE are located on the first uplink carrier and the third uplink carrier, respectively, and the UE is in the second uplink transmission chain state.

For the combination 0P+1P+0P of transmission of uplink channels or uplink reference signals at the transmission antenna port marked by the ellipse in Table 2, since the second uplink carrier transmits the uplink channel or uplink reference signal at one port, one uplink transmission chain is located on the second uplink carrier. If the second uplink carrier supports the two-port transmission mode, the UE can determine, by receiving a signaling (e.g., higher-layer signaling configuration), whether another uplink chain is located on the first uplink carrier, the second uplink carrier or the third uplink carrier. If the UE determines, by receiving the signaling (e.g., higher-layer signaling configuration), that another uplink chain is located on the second uplink carrier, two uplink transmission chains of the UE are located on the second uplink carrier, and the UE is in the fourth uplink transmission chain state. If the UE determines, by receiving the signaling (e.g., higher-layer signaling configuration), that another uplink chain is located on the first uplink carrier, two uplink transmission chains of the UE are located on the first uplink carrier and the second uplink carrier, respectively, and the UE is in the first uplink transmission chain state. If the UE determines, by receiving the signaling (e.g., higher-layer signaling configuration), that another uplink chain is located on the third uplink carrier, two uplink transmission chains of the UE are located on the second uplink carrier and the third uplink carrier, respectively, and the UE is in the third uplink transmission chain state.

For the combination 0P+0P+1P of transmission of uplink channels or uplink reference signals at the transmission antenna port marked by the thin rectangular box in Table 2, since the third uplink carrier transmits the uplink channel or uplink reference signal at one port, one uplink transmission chain is located on the third uplink carrier. If the third uplink carrier supports the two-port transmission mode, the UE can determine, by receiving a signaling (e.g., higher-layer signaling configuration), whether another uplink chain is located on the first uplink carrier, the second uplink carrier or the third uplink carrier. If the UE determines, by receiving the signaling (e.g., higher-layer signaling configuration), that another uplink chain is located on the third uplink carrier, two uplink transmission chains of the UE are located on the third uplink carrier, and the UE is in the sixth uplink transmission chain state. If the UE determines, by receiving the signaling (e.g., higher-layer signaling configuration), that another uplink chain is located on the first uplink carrier, two uplink transmission chains of the UE are located on the first uplink carrier and the third uplink carrier, respectively, and the UE is in the second uplink transmission chain state. If the UE determines, by receiving the signaling (e.g., higher-layer signaling configuration), that another uplink chain is located on the second uplink carrier, two uplink transmission chains of the UE are located on the second uplink carrier and the third uplink carrier, respectively, and the UE is in the third uplink transmission chain state.

### Example 2

When the UE is configured with four uplink carriers and the UE has two uplink transmission chains, there may be at most ten uplink transmission chain states. The ten uplink transmission chain states may be classified into two categories. One category is that two uplink transmission chains are located on two uplink carriers and the transmission mode corresponding to the two uplink carriers is one-port transmission. The other category is that two uplink transmission chains are located on one uplink carrier and the transmission mode corresponding to this uplink carrier is two-port transmission. The ten uplink transmission chain states will be specifically described below.

The first uplink transmission chain state is that the first uplink carrier is in the transmission mode of a single transmission chain, the second uplink carrier is in the transmission mode of a single transmission chain, the third uplink carrier is in the transmission mode of zero transmission chain and the fourth uplink carrier is in the transmission mode of zero transmission chain.

The second uplink transmission chain state is that the first uplink carrier is in the transmission mode of a single transmission chain, the second uplink carrier is in the transmission mode of zero transmission chain, the third uplink carrier is in the transmission mode of a single transmission chain and the fourth uplink carrier is in the transmission mode of zero transmission chain.

The third uplink transmission chain state is that the first uplink carrier is in the transmission mode of zero transmission chain, the second uplink carrier is in the transmission mode of a single transmission chain, the third uplink carrier is in the transmission mode of a single transmission chain and the fourth uplink carrier is in the transmission mode of zero transmission chain.

The fourth uplink transmission chain state is that the first uplink carrier is in the transmission mode of two transmission chains, the second uplink carrier is in the transmission mode of zero transmission chain, the third uplink carrier is in the transmission mode of zero transmission chain and the fourth uplink carrier is in the transmission mode of zero transmission chain.

The fifth uplink transmission chain state is that the first uplink carrier is in the transmission mode of zero transmission chain, the second uplink carrier is in the transmission mode of two transmission chains, the third uplink carrier is in the transmission mode of zero transmission chain and the fourth uplink carrier is in the transmission mode of zero transmission chain.

The sixth uplink transmission chain state is that the first uplink carrier is in the transmission mode of zero transmission chain, the second uplink carrier is in the transmission mode of zero transmission chain, the third uplink carrier is in the transmission mode of two transmission chains and the fourth uplink carrier is in the transmission mode of zero transmission chain.

The seventh uplink transmission chain state is that the first uplink carrier is in the transmission mode of a single transmission chain, the second uplink carrier is in the transmission mode of zero transmission chain, the third uplink carrier is in the transmission mode of zero transmission chain and the fourth uplink carrier is in the transmission mode of a single transmission chain.

The eighth uplink transmission chain state is that the first uplink carrier is in the transmission mode of zero transmission chain, the second uplink carrier is in the transmission mode of a single transmission chain, the third uplink carrier is in the transmission mode of zero transmission chain and the fourth uplink carrier is in the transmission mode of a single transmission chain.

The ninth uplink transmission chain state is that the first uplink carrier is in the transmission mode of zero transmission chain, the second uplink carrier is in the transmission mode of zero transmission chain, the third uplink carrier is in the transmission mode of a single transmission chain and the fourth uplink carrier is in the transmission mode of a single transmission chain.

The sixth uplink transmission chain state is that the first uplink carrier is in the transmission mode of zero transmission chain, the second uplink carrier is in the transmission mode of zero transmission chain, the third uplink carrier is in the transmission mode of zero transmission chain and the fourth uplink carrier is in the transmission mode of two transmission chains.

As shown in Table 3, in each uplink transmission chain state, the combinations of antenna ports for transmission of the uplink channel on the four configured uplink carriers are shown in Table 3. The uplink carrier in the transmission mode of a single transmission chain may be in one-port transmission (1P) or zero-port transmission (0P), and the uplink carrier in the transmission mode of two transmission chains may be in two-port transmission (2P) or one-port transmission (1P).

TABLE 3

| | | The number of transmission | Transmission antenna ports (the first |
|---|---|---|---|
| | | chains (the first uplink carrier + | uplink carrier + the second uplink |
| | | the second uplink carrier + the | carrier + the third uplink carrier + the |
| | | third uplink carrier + the fourth | fourth uplink carrier) |
| | | uplink carrier) | |
| First | uplink | 1T + 1T + 0T + 0T | [symbol] , 1P + 1P + 0P + 0P, |
| transmission | chain | | [symbol] |
| state | | | |
| Second | uplink | 1T + 0T + 1T + 0T | [symbol] , 1P + 0P + 1P + 0P, |
| transmission | chain | | [symbol] |
| state | | | |
| Third | uplink | 0T + 1T + 1T + 0T | [symbol] , 0P + 1P + 1P + 0P, |
| transmission | chain | | [symbol] |
| state | | | |
| Fourth | uplink | 0T + 2T + 0T + 0T | 2P + 0P + 0P + 0P, [symbol] |
| transmission | chain | | |
| state | | | |
| Fifth | uplink | 2T + 0T + 0T + 0T | 0P + 2P + 0P + 0P, [symbol] |
| transmission | chain | | |
| state | | | |
| Sixth | uplink | 0T + 0T + 2T + 0T | 0P + 0P + 2P + 0P, [symbol] |
| transmission | chain | | |
| state | | | |
| Seventh | uplink | 1T + 0T + 0T + 1T | [symbol] , 1P + 0P + 0P + 1P, |
| transmission | chain | | [symbol] |
| state | | | |
| Eight | uplink | OT + 1T + 0T + 1T | [symbol] , 0P + 1P + 0P + 1P, |
| transmission | chain | | [symbol] |
| state | | | |
| Ninth | uplink | 0T + 0T + 1T + 1T | [symbol] , 0P + 0P + 1P + 1P, |
| transmission | chain | | [symbol] |
| state | | | |
| Tenth | uplink | 0T + 0T + 0T + 2T | 0P + 0P + 0P+ 2P, [symbol] |
| transmission | chain | | |
| state | | | |

Above table 3 describes a correspondence among the uplink transmission chain states, the number of transmission chains and the transmission antenna ports.

It can be known from Table 3 that, in different uplink transmission chain states, there are combinations of transmission of uplink channels or uplink reference signals at the same transmission antenna port. For example, with reference to the combination 1P+0P+0P+0P of transmission of uplink channels or uplink reference signals at the transmission antenna port marked by the bold rectangular box, there is one-port transmission of the uplink channel or uplink reference signal on the first uplink carrier, and there are no transmission of the uplink channel or uplink reference signal on the second uplink carrier, the third uplink carrier, and the fourth uplink carrier. At this time, the uplink transmission chain state may be one of the first uplink transmission chain state, the second uplink transmission chain state, the fourth uplink transmission chain state, and the seventh uplink transmission chain state. Or, with reference to the combination 0P+1P+0P+0P of transmission of uplink channels or uplink reference signals at the transmission antenna port marked by the thin elliptic box, there is one-port transmission of the uplink channel or uplink reference signal on the second uplink carrier, and there is no transmission of the uplink channel or uplink reference signal on the first uplink carrier, the third uplink carrier and the fourth uplink carrier. At this time, the uplink transmission chain state may be one of the first uplink transmission chain state, the third uplink transmission chain state, the fifth uplink transmission chain state and the eighth uplink transmission chain state. Or, with reference to the combination 0P+0P+1P+0P of transmission of uplink channels or uplink reference signals at the transmission antenna port marked by the thin rectangular box, there is one-port transmission of the uplink channel or uplink reference signal on the third uplink carrier, and there is no transmission of the uplink channel or uplink reference signal on the first uplink carrier, the second uplink carrier and the fourth uplink carrier. At this time, the uplink transmission chain state may be one of the second uplink transmission chain state, the third uplink transmission chain state, the sixth uplink transmission chain state and the ninth uplink transmission chain state. Or, with reference to the combination 0P+0P+0P+1P of transmission of uplink channels or uplink reference signals at the transmission antenna port marked by the bold elliptic box, there is one-port transmission of the uplink channel or uplink reference signal on the fourth uplink carrier, and there is no transmission of the uplink channel or uplink reference signal on the first uplink carrier, the second uplink carrier and the third uplink carrier. At this time, the uplink transmission chain state may be one of the seventh uplink transmission chain state, the eighth uplink transmission chain state, the ninth uplink transmission chain state and the tenth uplink transmission chain state.

Thus, the UE determines according to the scheduling information received from the base station that one of the four uplink carriers is in one-port transmission (that is, one uplink transmission chain is located on one of the uplink carriers), but the specific uplink transmission chain state of the UE needs to be further determined. The determination method may refer to the determination of the carrier where another uplink transmission chain is located in one or more of the above ways in Example 1. For example, it can be determined through the higher-layer configuration whether the carrier where another uplink transmission chain is located and the determined one uplink carrier are the same carrier. If the carrier where another uplink transmission chain is located and the determined one uplink carrier are not the same carrier, the carrier where another uplink transmission chain is located can be further determined in any one of the above ways 1 to 7. Or, the pairing relationship or pairing rule between the uplink carriers is configured through a higher layer or predetermined through a protocol. After one uplink carrier that transmits the uplink channel or signal at one port is determined, the uplink carrier where another uplink transmission chain is located can be determined according to the pairing relationship or the pairing rule.

Similarly, if the UE is configured with more than four uplink carriers, the determination may be performed with reference to the above ways in Example 1.

Based on the solutions provided by the present disclosure, the base station can schedule resources in the communication system more flexibly, and can better improve the communication effect of the UE.

Based on the methods provided in embodiments of the present disclosure, an embodiment of the present disclosure further provides a user equipment. The user equipment may include a transceiver module and a resource determination module, wherein the transceiver module may be configured to receive first information transmitted by a base station, the first information includes related information of the scheduled uplink resource and transmission mode; and, the resource determination module may be configured to determine an uplink transmission chain state of the user equipment according to the first information.

Based on the methods provided in the embodiments of the present disclosure, an embodiment of the present disclosure further provides a base station. The base station may include a transceiver module, wherein the transceiver module may be configured to transmit first information to a user equipment, the first information is configured to determine an uplink transmission chain state of the user equipment;
wherein the first information includes the scheduled uplink resource and the corresponding transmission mode.

Optionally, the user equipment supports two uplink transmission chains, and the user equipment is configured with L uplink resources, where L≥3.

It should be understood that, the apparatus in embodiments of the present disclosure can execute the methods provided in the embodiments of the present disclosure, and the implementation principles thereof are similar. The actions performed by the modules in the apparatus in embodiments of the present disclosure correspond to the steps in the methods in embodiments of the present disclosure. The modules may be implemented by software and/or hardware. For the detailed functional description of the modules in the apparatus, reference may be made to the description of the corresponding methods shown above, and details will not be repeated here.

An embodiment of the present disclosure further provides a user equipment. The user equipment may include a transceiver and a processor, wherein the processor is coupled to the transceiver and configured to implement the method performed by a user equipment according to any one of optional embodiments of the present disclosure.

An embodiment of the present disclosure further provides a base station. The base station may include a transceiver and a processor, wherein the processor is coupled to the transceiver and configured to implement the method performed by a base station according to any one of optional embodiments of the present disclosure.

An embodiment of the present disclosure further provides a computer-readable storage medium having computer programs stored thereon that, when executed by a processor, can implement the method performed by a user equipment according to any one of optional embodiments of the present or the method performed by a base station according to any one of optional embodiments of the present disclosure.

As an optional implementation, FIG. 12 illustrates a schematic structural diagram of an electronic device to which an embodiment of the present disclosure is applicable, wherein the electronic device may be implemented as a user equipment or a base station, or part of a user equipment or a base station, the electronic device can be used to implement the method provided in any embodiments of the present disclosure.

As shown in FIG. 12, the electronic device 4000 may include: a processor 4001 and a memory 4003, and a transceiver 4004. Wherein, the processor 4001 communicates with the memory 4003, e.g., via a bus 4002. The transceiver 4004 may be used for data interaction between this electronic device and other electronic devices, such as data transmission and/or data reception. For example, the electronic device 4000 may be a user equipment, and the electronic device may communicate with a base station through a transceiver, receive a signal sent by the base station, and send a signal to the base station. It should be noted that the transceiver 4004 is not limited to one in practical applications, and the structure of the electronic device 4000 does not constitute a limitation of this application embodiment.

The processor 4001 may be a central processing unit (CPU), a general-purpose processor, a digital signal processor (DSP), an application specific integrated circuit (ASIC), and a field programmable gate array (FPGA), or other programmable logic device, transistor logic device, hardware component, or any combination thereof. It is possible to implement or execute the various exemplary logical blocks, modules and circuits described in combination with the disclosures of the present disclosure. The processor 4001 may also be a combination of computing functions, such as a combination of one or more microprocessor, a combination of a DSP and a microprocessor, and so on.

The bus 4002 can include a path for delivering information among the above components. The bus 4002 may be a peripheral component interconnect (PCI) bus or an extended industry standard architecture (EISA) bus. The bus 4002 may be divided into an address bus, a data bus, a control bus, and so on. For ease of illustration, only one bold line is shown in FIG. 12, but does not indicate that there is only one bus or type of bus.

The memory 4003 may be a read only memory (ROM) or other types of static storage devices that can store static information and instructions, a random access memory (RAM) or other types of storage devices that can store information and instructions. The memory 4003 may also be electrically erasable programmable read only memory (EEPROM), compact disc read only memory (CD-ROM) or other optical disk storage, optical disk storage (including compressed compact disc, laser disc, compact disc, digital versatile disc, blue-ray disc, etc.), magnetic disk storage medium or other magnetic storage device, or any other medium capable of carrying or storing computer programs and capable of being accessed by a computer, but not limited to this.

The memory 4003 is used to store computer programs for executing embodiments of the present disclosure and is controlled for execution by the processor 4001. The processor 4001 is used to execute the computer program stored in the memory 4003 to implement the steps shown in the preceding method embodiment.

FIG. 13 illustrates a block diagram illustrating a structure of a UE according to an embodiment of the disclosure. FIG. 13 corresponds to the example of the UE of FIG. 3A.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

FIG. 14 illustrates a block diagram illustrating a structure of a base station according to an embodiment of the disclosure. FIG. 14 corresponds to the example of the base station of FIG. 3B.

As shown in FIG. 14, the base station according to an embodiment may include a transceiver 1410, a memory 1420, and a processor 1430. The transceiver 1410, the memory 1420, and the processor 1430 of the base station may operate according to a communication method of the base station described above. However, the components of the base station are not limited thereto. For example, the base station may include more or fewer components than those described above. In addition, the processor 1430, the transceiver 1410, and the memory 1420 may be implemented as a single chip. Also, the processor 1430 may include at least one processor.

The transceiver 1410 collectively refers to a base station receiver and a base station transmitter, and may transmit/receive a signal to/from a terminal. The signal transmitted or received to or from the terminal may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the base station. Also, the memory 1420 may store control information or data included in a signal obtained by the base station. The memory 1420 may be a storage medium, such as read-only memory (ROM), random access memory (RAM), a hard disk, a CD-ROM, and a DVD, or a combination of storage media.

The processor 1430 may control a series of processes such that the base station operates as described above. For example, the transceiver 1410 may receive a data signal including a control signal transmitted by the terminal, and the processor 1430 may determine a result of receiving the control signal and the data signal transmitted by the terminal.

It should be understood that the terms “first”, “second”, “third”, “fourth”, “1”, “2”, etc. (if present) in the specification and claims of this disclosure and the accompanying drawings above are used to distinguish similar objects and need not be used to describe a particular order or sequence. It should be understood that the data so used is inter-changeable where appropriate so that embodiments of the present disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless ex-plicitly stated herein, in some implementation scenarios of embodiments of the present disclosure, the implementation steps in the respective flowcharts may be performed in other orders as desired. In addition, some or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The above-mentioned description is merely an alternative embodiment for some implementation scenarios of the present disclosure, and it should be noted that it would have been within the scope of protection of embodiments of the present disclosure for those skilled in the art to adopt other similar implementation means based on the technical idea of the present disclosure without departing from the technical concept of the solution of the present disclosure.

1-15. (canceled)

16. A user equipment (UE) in a wireless communication system, the UE comprising:
a transceiver; and
a controller coupled with the transceiver, and configured to:
receive, from a base station (BS), first information configuring a state of dual transmission (Tx) chains for an uplink (UL) Tx switching, the state of the dual UL Tx chains including a state of a first UL Tx chain and a second UL Tx chain,
transmit, to the BS, a first UL signal on a first UL carrier for a first band based on the first UL Tx chain and a second UL carrier for a second band based on the second UL Tx chain, and
in case that the first information indicates that one of the first UL Tx chain or the second UL Tx chain is supported on a carrier for each band, transmit, to the BS, a second UL signal on a third UL carrier for a third band based on the first UL Tx chain.

17. The UE of claim 16, wherein the controller is further configured to receive, from the BS, second information configuring an associated band for the UL Tx switching,
wherein the second information indicates the third band and a fourth band associated with the third band, and
wherein the second UL signal is transmitted on a fourth carrier for the fourth band based on the second ULL Tx chain.

18. The UE of claim 17, wherein each of the first UL signal and the second UL signal is transmitted at one port,
wherein the first information and the second information are received via a radio resource control (RRC) signaling, and
wherein the first information indicates that:
one of the first UL Tx chain or the second UL Tx chain is supported on the carrier for each band, or
both of the first UL Tx chain and the second UL Tx chain are supported on the carrier for the band.

19. The UE of claim 16, wherein a UL signal is not transmitted for a duration of switching gap between the transmission of the first LIE signal and the transmission of second UL signal.

20. A base station (BS) in a wireless communication system, the 13S comprising:
a transceiver; and
a controller coupled with the transceiver, and configured to:
transmit, to a user equipment (UE), first information configuring a state of dual transmission (Tx) chains for an uplink (UL) Tx switching, the state of the dual UL Tx chains including a state of a first UL Tx chain and a second UL Tx chain,
receive, from the UE, a first UL signal on a first UL carrier for a first band based on the first UL Tx chain and a second UL carrier for a second band based on the second UL Tx chain, and
in case that the first information indicates that one of the first UL Tx chain or the second UL Tx chain is supported on a carrier for each band, receive, from the BS, a second UL signal on a third UL carrier for a third band based on the first UL Tx chain.

21. The BS of claim 20, wherein the controller is further configured to transmit, to the LYE, second information configuring an associated band for the UL Tx switching,
wherein the second information indicates the third band and a fourth band associated with the third band, and
wherein the second UL signal is transmitted on a fourth carrier for the fourth band based on the second UL Tx chain.

22. The BS of 21 6, wherein each of the first UL signal and the second LL signal is received at one port,
wherein the first information and the second information are transmitted via a radio resource control (RRC) signaling, and
wherein the first information indicates that:
one of the first UL Tx chain or the second UL Tx chain is supported on the carrier for each band, or
both of the first UL Tx chain and the second UL Tx chain are supported on the carrier for the band.

23. The BS of claim 20, wherein a UL signal is not received for a duration of switching gap between the transmission of the first UL signal and the transmission of second UL signal.

24. A method performed by a user equipment (UE) in a wireless communication system, the method comprising:
receiving, from a base station (BS), first information configuring a state of dual transmission (Tx) chains for an uplink (UL) Tx switching, the state of the dual UL Tx chains including a state of a first UL Tx chain and a second UL Tx chain;
transmitting, to the BS, a first UL signal on a first UL carrier for a first band based on the first UL Tx chain and a second IL carrier for a second band based on the second UL Tx chain; and
in case that the first information indicates that one of the first UL Tx chain or the second UL Tx chain is supported on a carrier for each band, transmitting, to the BS, a second UL signal on a third ULL carrier for a third band based on the first UL Tx chain.

25. The method of claim 24, further comprising receiving, from the BS, second information configuring an associated band for the UL Tx switching,
wherein the second information indicates the third band and a fourth band associated with the third band, and
wherein the second UL signal is transmitted on a fourth carrier for the fourth band based on the second UL Tx chain.

26. The method of claim 25, wherein each of the first UL signal and the second UL signal is transmitted at one port,
wherein the first information and the second information are received via a radio resource control (RRC) signaling, and
wherein the first information indicates that:
one of the first UL Tx chain or the second UL Tx chain is supported on the carrier for each band, or
both of the first UL Tx chain and the second UL Tx chain are supported on the carrier for the band.

27. The method of claim 24, wherein a UL signal is not transmitted for a duration of switching gap between the transmission of the first LL signal and the transmission of second UL signal.

28. A method performed by abase station (BS) in a wireless communication system, the method comprising:
transmitting, to a user equipment (UE), first information configuring a state of dual transmission (Tx) chains for an uplink (UL) Tx switching, the state of the dual UL Tx chains including a state of a first UL Tx chain and a second UL Tx chain;
receiving, from the UE, a first UL signal on a first UL carrier for a first band based on the first UL Tx chain and a second UL carrier for a second band based on the second UL Tx chain; and
in case that the first information indicates that one of the first UL Tx chain or the second UL Tx chain is supported on a carrier for each band, receiving, from the BS, a second UL signal on a third UL carrier for a third band based on the first UL Tx chain.

29. The method of claim 28, further comprising transmitting, to the UE, second information configuring an associated band for the UL Tx switching,
wherein the second information indicates the third band and a fourth band associated with the third band, and
wherein the second UL signal is transmitted on a fourth carrier for the fourth band based on the second UL: Tx chain.

30. The method of claim 29, wherein each of the first UL signal and the second UL signal is received at one port,
wherein the first information and the second information are transmitted via a radio resource control (RRC) signaling, and
wherein the first information indicates that:
one of the first UL Tx chain or the second LL Tx chain is supported on the carrier for each band, or
both of the first UL Tx chain and the second UL Tx chain are supported on the carrier for the band.

31. The method of claim 28, wherein a UL signal is not received for a duration of switching gap between the transmission of the first UL signal and the transmission of second UL signal.
